(19) United States
(12) Patent Application Publication
(10) Pub. No.: US 2016/0111980 A1
(43) Pub. Date: Apr. 21, 2016

(54) ENERGY HARVESTING DEVICE AND METHOD OF HARVESTING ENERGY

(71) Applicant: AGENCY FOR SCIENCE, TECHNOLOGY AND RESEARCH, Singapore (SG)

(72) Inventors: Chengliang Sun, Singapore (SG); Xiaojing Mu, Singapore (SG); Peter Hyun Kee Chang, Singapore (SG); Qingxin Zhang, Singapore (SG); Alex Yuandong Gu, Singapore (SG); Wei Mong Tsang, Singapore (SG)

(21) Appl. No.: 14/895,838

(22) PCT Filed: Jun. 23, 2014
(86) PCT No.: PCT/SG2014/000297

§ 371 Date: Dec. 3, 2015

(30) Foreign Application Priority Data
Jun. 21, 2013 (SG) 201304854-1
Nov. 22, 2013 (SG) 201308683-0

(51) Int. Cl. H02N 2/18

(52) U.S. Cl. CPC H02N 2/185

(57) ABSTRACT

According to embodiments of the present invention, an energy harvesting device is provided. The energy harvesting device includes a microchannel arranged to receive a fluid, a bluff body arranged to interact with the fluid flowing through the microchannel to generate a vortex fluid street, and an energy harvesting element arranged to interact with the vortex fluid street to harvest energy from the fluid. According to further embodiments of the present invention, a method of harvesting energy is also provided.

### CROSS-REFERENCE TO RELATED APPLICATIONS

This application claims the benefit of priority of Singapore patent application No. 201304854-1, filed 21 Jun. 2013, and Singapore patent application No. 201308683-0, filed 22 Nov. 2013, the contents being hereby incorporated by reference in their entireties for all purposes.

### TECHNICAL FIELD

Various embodiments relate to an energy harvesting device and a method of harvesting energy.

### BACKGROUND

Harvesting energy from ambient mechanical energy or motion has shown a promising strategy for wireless sensor or network applications, especially self powered electronics device. Similarly, in the healthcare realm, implantable biomedical devices like pacemakers have urgent demands to be self-powered. Wireless sensors, as well as micro-systems integrating both micromechanical devices with microelectronics, have become smaller, more sophisticated and less expensive, specifically for implantable biomedical devices. Thus, miniature energy harvester system has shown a booming trend in the recent ten years.

Harvesting energy from a low frequency vibration and low velocity fluid flow source is challenging. There is no vortex shedding effect with a low frequency fluid flow source such as breath, and other human activities. Human body motion, as one of mechanical energy sources, is useful for harvesting energy to power implanted bio-sensors. However, it is a challenge to harvest these energies of low frequency from human motions. Hence, a method of up-regulating the fluid flow linear velocity, frequency up-conversion and high power generation are necessary for energy harvesters. The energy harvesting capabilities of a piezoelectric energy harvester depends on the vibration source from which the energy can be extracted, the electromechanical properties of the piezoelectric material, and the structure of the device in which the energy conversion takes place. Different piezoelectric materials have been studied for energy harvesting and proved to be effective only under certain circumstances.

Energy harvesting efficiency is proportional to the device size, which is low for a miniaturized energy harvester that captures energy from low frequency ambient sources. Prior art fluid flow induced or flow-driven piezoelectric energy harvesters of various structures usually suffer from low harvesting efficiency due to a low fluid flow linear velocity or low frequency vibration of the flow source. Belts or micro-belts are used to harvest fluid flow energy in some devices, but they do not have special design to accelerate the fluid flow and shorten the vortex shedding generation time. Further, belts or micro-belts like structures, as flow energy harvesting elements of energy harvesters, always have a delay time of several seconds or even longer before they are fully vibrated, which makes them not compatible to be utilized in low frequency flow instances.

With the recent development of wireless sensors or wireless network such as bio-sensors, implantable bio-sensors and TPMS (tire pressure monitor system), which work in low frequency vibration source, a design or strategy for harvesting low frequency ambient vibration energy with sufficient energy transfer efficiency with a miniaturized energy device is desired.

### SUMMARY

According to an embodiment, an energy harvesting device is provided. The energy harvesting device may include a microchannel arranged to receive a fluid, a bluff body arranged to interact with the fluid flowing through the microchannel to generate a vortex fluid street, and an energy harvesting element arranged to interact with the vortex fluid street to harvest energy from the fluid.

According to an embodiment, a method of harvesting energy is provided. The method may include receiving a fluid, letting the fluid flow through a microchannel of an energy harvesting device, arranging a bluff body of the energy harvesting device to interact with the fluid flowing through the microchannel to generate a vortex fluid street, and arranging an energy harvesting element of the energy harvesting device to interact with the vortex fluid street to harvest energy from the fluid.

### BRIEF DESCRIPTION OF THE DRAWINGS

In the drawings, like reference characters generally refer to like parts throughout the different views. The drawings are not necessarily to scale, emphasis instead generally being placed upon illustrating the principles of the invention. In the following description, various embodiments of the invention are described with reference to the following drawings, in which:

FIG. 1 shows an overall configuration of an energy harvesting system.

FIG. 2A shows a schematic cross-sectional view of an energy harvesting device, according to various embodiments.

FIG. 2B shows a flow chart illustrating a method of harvesting energy, according to various embodiments.

FIGS. 3A to 3C show examples of an overall bi-directional and uni-directional fluid container system for an energy harvesting system.

FIGS. 4A to 4C respectively show an energy harvesting device, according to various embodiments.

FIG. 5 shows a schematic cross-sectional view of an energy harvesting element, according to various embodiments.

FIGS. 6A to 6E respectively show an overall energy harvesting element structure and type, according to various embodiments.

FIG. 7 shows plots of simulation results of the generated displacement of the micro-belt and the distribution of the fluid linear velocity.

FIG. 8 shows a plot of simulation results of the generated pressure distribution on the surface of the micro-belt.

FIG. 9A shows a plot of simulation results of the displacement of the piezoelectric micro-belt.

FIG. 9B shows a plot of peak to peak displacement results for the piezoelectric micro-belt.

FIGS. 10A and 10B show respective plots of the generated open-circuit voltage and the output power of the energy harvesting device of various embodiments.

FIG. 11 shows plots of the generated open circuit voltage and the corresponding frequency spectra of the energy harvesting device of various embodiments.

FIG. 12A shows a schematic of a traditional Helmholtz resonating cavity, while FIG. 12B shows a double sided clamped beam.

FIG. 13 shows a schematic of an energy harvester system, according to various embodiments.

FIGS. 14A to 14C respectively show an energy harvesting device, according to various embodiments.

FIGS. 15A to 15C respectively show an energy harvesting device, according to various embodiments.

FIGS. 16A to 16D respectively show an energy harvesting device, according to various embodiments.

FIGS. 17A and 17B show respective plots of simulated fluid behaviour in a cavity without a bluff body, and with a bluff body.

FIGS. 18A and 18B show respective plots of simulated fluid behaviour in a cavity array with respective bluff bodies.

FIG. 19 shows a plot of the peak to peak output voltage and the resonant frequency versus the input air pressure.

FIGS. 20A and 20B show plots of time spectra and frequency spectra, respectively, of Vₒₚₑₙ corresponding to an energy harvesting device with three cavities.

### DETAILED DESCRIPTION

The following detailed description refers to the accompanying drawings that show, by way of illustration, specific details and embodiments in which the invention may be practiced. These embodiments are described in sufficient detail to enable those skilled in the art to practice the invention. Other embodiments may be utilized and structural, logical, and electrical changes may be made without departing from the scope of the invention. The various embodiments are not necessarily mutually exclusive, as some embodiments can be combined with one or more other embodiments to form new embodiments.

Embodiments described in the context of one of the methods or devices are analogously valid for the other methods or devices. Similarly, embodiments described in the context of a method are analogously valid for a device, and vice versa.

Features that are described in the context of an embodiment may correspondingly be applicable to the same or similar features in the other embodiments. Features that are described in the context of an embodiment may correspondingly be applicable to the other embodiments, even if not explicitly described in these other embodiments. Furthermore, additions and/or combinations and/or alternatives as described for a feature in the context of an embodiment may correspondingly be applicable to the same or similar feature in the other embodiments.

In the context of various embodiments, the articles “a”, “an” and “the” as used with regard to a feature or element include a reference to one or more of the features or elements.

In the context of various embodiments, the phrase “at least substantially” may include “exactly” and a reasonable variance.

In the context of various embodiments, the term “about” or “approximately” as applied to a numeric value encompasses the exact value and a reasonable variance.

As used herein, the term “and/or” includes any and all combinations of one or more of the associated listed items.

As used herein, the phrase of the form of “at least one of A or B” may include A or B or both A and B. Correspondingly, the phrase of the form of “at least one of A or B or C”, or including further listed items, may include any and all combinations of one or more of the associated listed items.

Various embodiments may relate to fields such as fluid flow induced vortex shedding, vibration-induced piezoelectric energy harvesting, energy harvester, bluff-body induced vortex shedding in fluid stream, Helmholtz resonance, and MEMS (Microelectromechanical systems) energy harvester involved wireless network.

Various embodiments may relate to Micro Electro Mechanical Systems (MEMS) technology, for example an energy harvesting system or device with frequency up conversion utilizing fluid vortex shedding effect.

Various embodiments may relate to piezoelectric micromechanical energy harvesters, for example for applications such as bio-sensors and TPMS (tire pressure monitor system), and other applications.

Various embodiments may relate to an energy harvesting device for improving the energy harvesting efficiency.

Various embodiments may provide a miniaturized energy harvester device or system by using fluid flow energy. The device may include a uni- or bi-directional fluid container to generate fluid flow, and a microchannel or multi microchannels to accelerate the fluid flow linear velocity.

Various embodiments may provide a miniaturized energy harvester or energy harvesting device for wireless applications.

Various embodiments may provide a method for frequency up conversion of an energy harvesting system. The method of frequency up conversion of various embodiments may also be extended for other types of sensors which may utilize vortex shedding effect. The energy harvester system or device of various embodiments may include uni- or bi-directional fluid container with one or more microchannels and one or more piezoelectric micro-belts which may be positioned to flow adjacent to one or more bluff bodies. This may mean that the fluid container may have uni- or bi-directional function. The uni- or bi-directional fluid container with a microchannel or multi microchannels may be used as a fluid flow source. The fluid container with microchannel(s) may be used to store energy from pressure differential, acceleration or other sources into pressurized fluids and eject the pressurized fluid(s) uni- or bi-directionally. The bluff body may generate a vortex shedding street. A piezoelectric micro-belt may be positioned on or in the vortex street. The piezoelectric micro-belt may work as a device sensing layer. The piezoelectric micro-belt may generate a vibration as a result of the vortex lift force. The piezoelectric micro-belt may generate piezoelectric charge due to the vibration by piezoelectric coupling co-effect. In this way, the piezoelectric micro-belt may harvest energy from the fluid flow utilizing vortex shedding effect. The up-regulated flow linear velocity and the bluff body may up-convert the low frequency flow/vibration source to high frequency vortex shedding. The piezoelectric micro-belt(s) may vibrate in the vortex street and harvest flow energy due to the vortex shedding effect. The frequency up conversion may improve the harvesting efficiency and shrink the size of the energy harvesters for implantable, for example in bio applications.

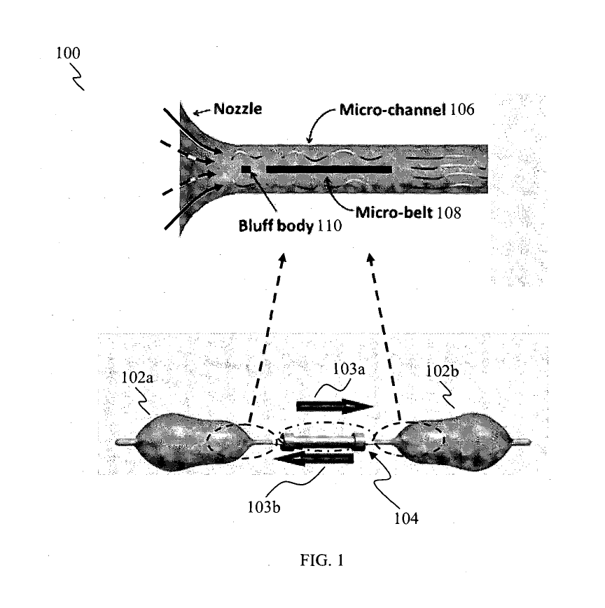

Various embodiments may provide a special or custom designed energy harvester system incorporating frequency up conversion. FIG. 1 shows an overall configuration of an energy harvesting system 100, illustrating an energy harvester system model. The system may include a first bladder 102a and a second bladder 102b coupled to an energy harvester (e.g. a piezoelectric energy harvester) 104. The energy harvester or energy harvesting device 104 may be as described later below. The system 100 may include uni- or bi-directional fluid container(s) coupled with microchannels (e.g. 106) and piezoelectric micro-belt(s) 108 coupled with a bluff body 110. The fluid container(s) coupled with microchannels may be used to store energy from pressure differential, acceleration or other sources into pressurized fluids and eject the pressurized fluid(s) uni- or bi-directionally (e.g. as represented by the arrows 103a, 103b) from a low frequency source. The piezoelectric micro-belts 108 coupled with bluff bodies (e.g. 110) may be used to harvest fluid flow energy utilizing vortex shedding effect.

The energy harvesting device of various embodiments may include specific module(s) coupled with a microchannel design and one or more piezoelectric micro-belts coupled with a bluff body design. In order to miniaturize the energy harvester device or system, the device may use a uni- or bi-directional fluid container arrangement to store energy from pressure differential, acceleration or other sources into pressurized fluids and eject the pressurized fluid(s) uni- or bi-directionally from a low frequency source. The device may also employ a microchannel or multi microchannels to accelerate fluid flow. In order to improve the energy harvesting efficiency, the device or system may use one or more piezoelectric micro-belt(s) coupled with one or more bluff bodies to generate a vibration of the micro-belt(s) due to fluid vortex shedding effect and convert mechanical energy to electrical energy by piezoelectric coupling co-effect.

In various embodiments, the harvesting frequency of the energy harvester may be up-converted utilizing a vortex shedding effect by using a bluff body which may be put in front of the piezoelectric micro-belt. The bluff body, which may be placed in front of a piezoelectric micro-belt, may shorten the latent time of the vortex shedding generation as compared to other structures. The bluff body may be a circle, a square or any other types of structures. The bluff body may be made of any kind of solid materials.

In various embodiments, the piezoelectric material may be any kinds of piezoelectric material such as aluminium nitride (or aluminum nitride) (AlN), zinc oxide (ZnO), lithium niobate (LiNbO3), or lead zirconium titanate (PZT) or any other piezoelectric materials. A substrate may be provided with the piezoelectric material. The piezoelectric/substrate structure may be any type of micro-belts and cantilevers. The substrate of the micro-belt may be any kind of solid materials such as silicon (Si), copper (Cu), aluminium (Al) or other suitable solid materials.

In various embodiments, a microchannel may be used to up-regulate the fluid flow linear velocity. This high linear velocity fluid may generate a high frequency vortex shedding when the fluid encounters a bluff body placed in front of a piezoelectric micro-belt, where the piezoelectric micro-belt may vibrate in the vortex street. The vibration frequency of the micro-belt may be up-converted by utilizing the vortex shedding effect, which may result in a decreased device size and an improved harvesting efficiency.

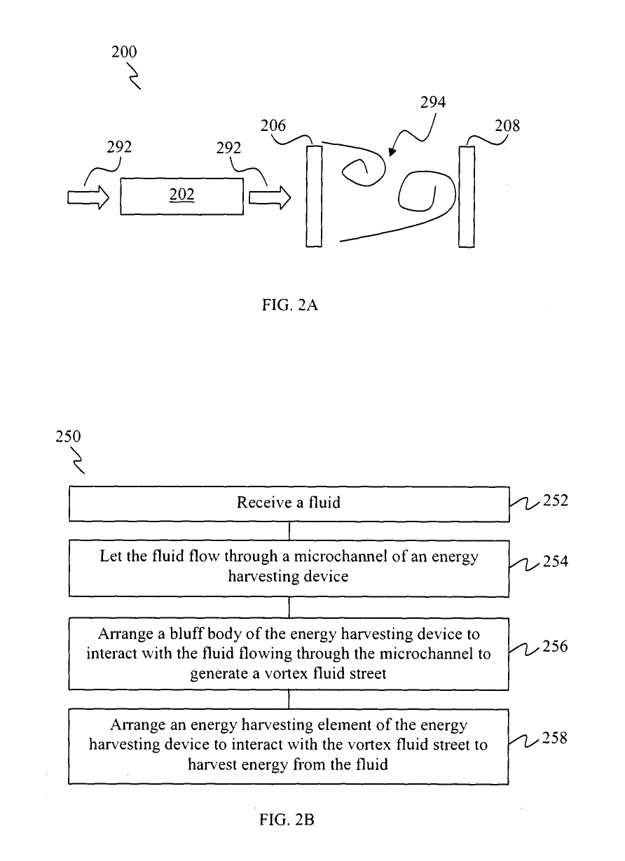

FIG. 2A shows a schematic top view of an energy harvesting device 200, according to various embodiments. The energy harvesting device 200 includes a microchannel 202 arranged to receive a fluid 292, a bluff body 206 arranged to interact with the fluid 292 flowing through the microchannel to generate a vortex fluid street 294, and an energy harvesting element 208 arranged to interact with the vortex fluid street 294 to harvest energy from the fluid 292. As a result, the energy harvesting device 200 may harvest fluid flow energy.

In other words, an energy harvesting device or an energy harvester 200 may be provided, which may include a microchannel 202 which may receive a fluid (e.g. air) 292. The fluid 292 may flow in and through the microchannel 202. The microchannel 202 may be adapted to up-convert or up-regulate (e.g. increase) the velocity (e.g. linear velocity) of the fluid 292.

The energy harvesting device 200 may further include a bluff body 206 which may interact with the fluid 292. The bluff body 206 may be arranged in or within the path of the fluid 292. In this way, the bluff body 206 may be an obstruction to the flow of the fluid 292. As a result of the interaction between the bluff body 206 and the fluid 292, a vortex fluid street (or vortex shedding street) 294 may be generated in a down-flow direction relative to the bluff body 206. There may be a vortex shedding effect in the vortex fluid street 294. In various embodiments, the bluff body 206 may up-convert or increase the low frequency flow of the fluid 292 to a high frequency vortex fluid street 294 or high frequency vortex shedding fluid flow.

The energy harvesting device 200 may further include an energy harvesting element 208 arranged to harvest or generate energy from the fluid 292 in response to the interaction with the vortex fluid street 294. The energy harvesting element 208 may harvest or generate energy from the fluid flow of the vortex fluid street 294 based on the vortex shedding effect. For example, the vortex shedding effect in the vortex fluid street 294 may provide periodic vortex shedding which may induce periodic pressure variations on the energy harvesting element 208.

While FIG. 2A illustrates that the bluff body 206 and the energy harvesting element 208 may be arranged at least substantially parallel to each other, it should be appreciated that the energy harvesting element 208 may be arranged at least substantially perpendicularly to the bluff body 206.

In various embodiments, the microchannel 202, the bluff body 206 and the energy harvesting element 208 may be arranged coaxially.

In the context of various embodiments, the term “bluff body” may mean a body or structure that may experience drag that may be dominated by pressure drag, rather than viscous drag. Further, a bluff body may mean a body or structure which may be of an angular shape, rather than an aerodynamic shape.

In various embodiments, the energy harvesting element 208 may be arranged spaced apart from the bluff body 206, as illustrated in FIG. 2A.

In various embodiments, the energy harvesting element 208 may be coupled (e.g. directly coupled) to the bluff body 206.

In various embodiments, the energy harvesting element 208 may be movable in response to the interaction with the vortex fluid street 294 to convert kinetic energy (or mechanical energy) into electrical energy. For example, the energy harvesting element 208 may be movable as a result of vortex lift force. The movement frequency of the energy harvesting element 208 may be up-converted by the vortex shedding effect.

In various embodiments, the energy harvesting element 208 may be configured to vibrate in response to the interaction with the vortex fluid street 294 to convert kinetic energy (or mechanical energy) into electrical energy. For example, the energy harvesting element 208 may vibrate or oscillate, e.g. due to the fluid vortex shedding effect of the vortex fluid street 294. The vibration frequency of the energy harvesting element 208 may be up-converted by the vortex shedding effect.

In the context of various embodiments, the energy harvesting element 208 may include a piezoelectric structure (or piezoelectric resonator). This may mean that the energy harvesting element 208 may convert kinetic or mechanical energy to electrical energy by piezoelectric coupling effect. The piezoelectric structure (or piezoelectric resonator) may include at least one of aluminum nitride (AlN), zinc oxide (ZnO), lithium niobate (LiNbO₃), or lead zirconium titanate (PZT). It should be appreciated that other piezoelectric materials may be employed.

In various embodiments, the energy harvesting element 208 may further include a pair of electrodes arranged on opposite surfaces of the piezoelectric structure (or piezoelectric resonator). For example, an electrode may be arranged on a top surface of the piezoelectric structure and another electrode may be arranged on a bottom surface of the piezoelectric structure.

In various embodiments, the energy harvesting element 208 may further include a substrate, and the piezoelectric structure (or piezoelectric resonator) may be arranged on the substrate. The substrate may include silicon (Si), copper (Cu) or aluminium (Al). It should be appreciated that other solid materials may also be employed for the substrate.

In various embodiments, the energy harvesting element 208 may be arranged in or within the path of the vortex fluid street 294 to be generated. This may mean that the energy harvesting element 208 may be arranged to intercept the vortex fluid street 294 to be generated.

In various embodiments, the bluff body 206 may be arranged between the microchannel 202 and the energy harvesting element 208. This may mean that the bluff body 206 may be arranged to interact with the fluid 292 flowing through and out of the microchannel 202. For example, the bluff body 206 may be arranged in front of the energy harvesting element 208.

In various embodiments, the microchannel 202 may be arranged in up-flow direction of the fluid 292 relative to the bluff body 206 and the energy harvesting element 208 may be arranged in down-flow direction of the fluid 292 relative to the bluff body 206.

In various embodiments, the energy harvesting element 208 may be arranged in a cavity. The cavity may be in fluid communication with the microchannel 202. This may mean that the microchannel 202 may define the inlet or orifice of the cavity. In various embodiments, the bluff body 206 may be arranged at an inlet or orifice or entrance of the cavity. This may mean that the bluff body 206 may generate the vortex fluid street 294 into the cavity, or in other words, the vortex fluid street 294 that is generated may propagate within the cavity.

In the context of various embodiments, the cavity may be or may include a Helmholtz cavity (e.g. a Helmholtz resonator or a Helmholtz resonating cavity). The Helmholtz cavity may be in fluid communication with the microchannel 202. In various embodiments, the bluff body 206 may be arranged at an inlet or orifice or entrance of the Helmholtz cavity. This may mean that the microchannel 202 may define the inlet or orifice of the Helmholtz cavity. Arranging the bluff body 206 at the entrance of the Helmholtz cavity may help to enhance the Helmholtz resonance of the Helmholtz cavity. In various embodiments, the fluid 292 flowing through the Helmholtz cavity may be partially trapped in the Helmholtz cavity and excited to resonate at the Helmholtz resonating frequency, which may be determined by the Helmholtz cavity dimensions.

In the context of various embodiments, each of the cavity or the Helmholtz cavity may have any size but at least has a size which may provide sufficient room or space for the energy harvesting element 208 (e.g. a micro-belt) to move or vibrate. In various embodiments, as the operating frequency of the energy harvesting device 200 may be pre-defined or determined by the size or dimension of the Helmholtz cavity, the size to be employed for the Helmholtz cavity may be determined based on this relationship.

In the context of various embodiments, the Helmholtz cavity may have an associated resonant frequency. The resonant frequency of the Helmholtz cavity may depend, for example, on the volume of the cavity Helmholtz and the size of the orifice. In various embodiments, the orifice may be defined by the microchannel 202 or a plurality of microchannels 202. The microchannel(s) 202 may be rectangular shaped.

In the context of various embodiments, by incorporating a Helmholtz cavity, the operating frequency of the energy harvesting device 200 may be determined by the physical sizes of the Helmholtz cavity and its corresponding orifice and may be independent of the input fluid flow rate. This may simplify the associated ASIC (application-specific integrated circuit) design of the energy harvesting device 200 and may simultaneously improve the energy storage efficiency. Further, the bluff body 206 may enhance the Helmholtz resonance and lower the threshold of input fluid pressure.

In the context of various embodiments, the cavity or the Helmholtz cavity may have a cylindrical shape, a cubic shape or a cuboid shape. However, it should be appreciated that any other shape may be provided for the cavity or the Helmholtz cavity.

In embodiments employing a Helmholtz cavity, movement or vibration of the energy harvesting element 208 may be governed by resonance in the Helmholtz cavity, and the resonating frequency may be independent of inlet flow velocity and frequency. An optimum or maximum output energy or power may be harvested when the natural frequency of the energy harvesting element 208 may be at least substantially matched to that of the Helmholtz cavity. In this way, the harvesting frequency of the energy harvesting element 208 and the energy harvesting device 200 may be up-converted and governed by the Helmholtz cavity. This may mean that the operating frequency of the energy harvesting element 208 and the energy harvesting device 200 may be pre-defined or determined by the size or dimension of the Helmholtz cavity.

In various embodiments, the energy harvesting device 200 may include a plurality of microchannels 202 arranged to receive the fluid 292. This may mean that the bluff body 206 may be arranged to interact with the fluid 292 flowing through the plurality of microchannels 202. The plurality of microchannels 202 may be arranged parallel to each other. The plurality of microchannels 202 may be arranged spaced apart from each other.

In various embodiments, the energy harvesting device 200 may include a plurality of energy harvesting elements 208 arranged to interact with the vortex fluid street 294. Each of the plurality of energy harvesting elements 208 may include a piezoelectric structure (or piezoelectric resonator) described above. The plurality of energy harvesting elements 208 may be arranged within the cavity described above. The plurality of energy harvesting elements 208 may be arranged parallel to each other. The plurality of energy harvesting elements 208 may be arranged spaced apart from each other. The plurality of energy harvesting elements 208 may be arranged side by side. The plurality of energy harvesting elements 208 may be arranged one over the other, for example in a top and bottom arrangement. The plurality of energy harvesting elements 208 may be arranged one after the other in a direction along the propagation of the vortex fluid street 294 to be generated. This may mean that the plurality of energy harvesting elements 208 may be arranged one after the other in a direction away from the bluff body 206.

In various embodiments, at least one energy harvesting element 208 of the plurality of energy harvesting elements 208 may be arranged in a respective cavity, the cavities being arranged in fluid communication with each other. Accordingly, this may mean that the energy harvesting device 200 may include a plurality of cavities. One or more of the cavities may be or may include a Helmholtz cavity.

In various embodiments, the energy harvesting device 200 may further include a fluid container arranged in fluid communication with the microchannel 202, the fluid container configured to contain the fluid 292 to be received by the microchannel 202. A fluid may be pressurized or accelerated into the fluid container, or in other words an accelerated or pressurized fluid may be provided into the fluid container, from which the fluid 292 may be received by the microchannel 202. In various embodiments, the fluid container may be compressible.

In various embodiments, the energy harvesting device 200 may further include an additional microchannel arranged to receive the fluid 292, an additional bluff body arranged to interact with the fluid 292 flowing through the additional microchannel to generate an additional vortex fluid street, and wherein the energy harvesting element 208 may be arranged to interact with the additional vortex fluid street. In various embodiments, the energy harvesting element 208 may be arranged in between the bluff body 206 and the additional bluff body. A plurality of additional microchannels may be provided. In various embodiments, the additional microchannel or plurality of additional microchannels may also be adapted to let the fluid 292 out.

In the context of various embodiments, the microchannel or plurality of microchannels 202 and/or the additional microchannel or plurality of additional microchannels may allow bi-directional flow of the fluid 292 through the corresponding microchannel.

In the context of various embodiments, each microchannel 202 and/or each additional microchannel may have a rectangular shape.

In various embodiments, the microchannel 202 and the bluff body 206 may be arranged on one side of the energy harvesting element 206, and the additional microchannel and the additional bluff body may be arranged on the opposite side of the energy harvesting element 208. The energy harvesting device 200 may further include an additional fluid container arranged in fluid communication with the additional microchannel.

In the context of various embodiments, the (or each) energy harvesting element 208 may include at least one of a micro-belt, a micro-blade, a micro-wire, a micro-cantilever beam, a double clamped beam, a micro-net, a micro-ring, a micro-leaf, or a butterfly wing. However, it should be appreciated that other shapes or structures may be provided for the (or each) energy harvesting element 208.

In the context of various embodiments, the (or each) energy harvesting element 208 may be a suspended structure. For example, the (or each) energy harvesting element 208 may be suspended from a carrier on which the energy harvesting device 200 may be formed or may be suspended by being coupled to anchoring structures.

In the context of various embodiments, the (or each) energy harvesting element 208 may have a width in a range of between about 0.5 mm and about 5 mm, for example between about 0.5 mm and about 3 mm, between about 0.5 mm and about 1 mm, or between about 1 mm and about 5 mm, e.g. about 1 mm. The (or each) energy harvesting element 208 may have a length in a range of between about 5 mm and about 20 mm, for example between about 5 mm and about 10 mm, between about 10 mm and about 20 mm, or between about 8 mm and about 15 mm, e.g. about 10 mm. The (or each) energy harvesting element 208 may have a thickness in a range of between about 10 μm and about 30 μm, for example between about 10 μm and about 20 μm, between about 20 μm and about 30 μm, or between about 15 μm and about 25 μm, e.g. about 20 μm. However, it should be appreciated that the (or each) energy harvesting element 208 may have any suitable width and/or length and/or thickness. In various embodiments, the length of the (or each) energy harvesting element 208 may be larger than its corresponding width, while the width may be larger than its corresponding thickness, e.g. length>width>thickness. For example, the (or each) energy harvesting element 208 may have a ratio of length:width:thickness of 100:10:1.

In the context of various embodiments, at least one of the bluff body 206 or the additional bluff body may have a width in a range of between about 10 μm and about 30 μm, for example between about 10 μm and about 20 μm, between about 20 μm and about 30 μm, or between about 15 μm and about 25 μm, e.g. about 20 μm. At least one of the bluff body 206 or the additional bluff body may have a length in a range of between about 200 μm and about 500 μm, for example between about 200 μm and about 400 μm, between about 300 μm and about 500 μm, or between about 350 μm and about 450 μm, e.g. about 400 μm. At least one of the bluff body 206 or the additional bluff body may have a thickness in a range of between about 10 μm and about 30 μm, for example between about 10 μm and about 20 μm, between about 20 μm and about 30 μm, or between about 15 μm and about 25 μm, e.g. about 20 μm. However, it should be appreciated that at least one of the bluff body 206 or the additional bluff body may have any suitable width and/or length and/or thickness. In various embodiments, the length of the bluff body 206 and/or the additional bluff body may be larger than its corresponding width and/or thickness. In various embodiments, the width and the thickness of the bluff body 206 may be at least substantially similar or identical. Similarly, the additional bluff body may have a width and a thickness that may be at least substantially similar or identical. For example, at least one of the bluff body 206 or the additional bluff body may have a ratio of length:width:thickness of 10:1:1 or 5:1:1.

In the context of various embodiments, at least one of the bluff body 206 or the additional bluff body may include at least one of a belt (e.g. micro-belt), a tube (e.g. micro-tube), a wire (e.g. micro-wire), a beam (e.g. micro-beam), or a pillar (e.g. micro-pillar). However, it should be appreciated that other structures may be provided.

In the context of various embodiments, at least one of the bluff body 206 or the additional bluff body may have a shape that is elongate (e.g. a beam), circular, rectangular, or square. However, it should be appreciated that other shapes may be provided.

In the context of various embodiments, at least one of the bluff body 206 or the additional bluff body may be or may include any types of solid materials.

In the context of various embodiments, the (or each) microchannel 202 and/or each additional microchannel may be in the form of a nozzle.

In the context of various embodiments, the term “fluid” may refer to air, gas or liquid.

FIG. 2B shows a flow chart 250 illustrating a method of harvesting energy, according to various embodiments.

At 252, a fluid is received.

At 254, the fluid is let to flow through a microchannel of an energy harvesting device. This for example may assist in increasing a velocity of the fluid.

At 256, a bluff body of the energy harvesting device may be arranged to interact with the fluid flowing through the microchannel to generate a vortex fluid street.

At 258, an energy harvesting element of the energy harvesting device may be arranged to interact with the vortex fluid street to harvest energy from the fluid.

In various embodiments, the bluff body may be arranged at an inlet or entrance of a Helmholtz cavity (or Helmholtz resonating cavity) of the energy harvesting device, and the energy harvesting element may be arranged in the Helmholtz cavity. Arranging the bluff body at an inlet or entrance of the Helmholtz cavity (or Helmholtz resonating cavity) of the energy harvesting device may help to enhance the Helmholtz resonance of the Helmholtz cavity. The Helmholtz cavity may be in fluid communication with the microchannel.

In various embodiments, the method may further include letting the fluid flow out of the Helmholtz cavity through an additional microchannel of the energy harvesting device. The Helmholtz cavity may be in fluid communication with the additional microchannel.

Various embodiments may also provide a method of harvesting energy, the method including receiving a fluid, letting the fluid flow through a microchannel (or multi-microchannels or plurality of microchannels) of an energy harvesting device, arranging an energy harvesting element of the energy harvesting device in a Helmholtz resonating cavity (or Helmholtz cavity) to harvest energy from the fluid, arranging a bluff body of the energy harvesting device at an entrance or inlet of the Helmholtz resonating cavity to interact with the fluid flowing through the microchannel (or multi-microchannels or plurality of microchannels) to generate a vortex fluid street to enhance the Helmholtz resonating (or resonance), and arranging another or additional microchannel (or multi-microchannels or plurality of microchannels) of the energy harvesting device to let the fluid flow out, e.g. out of the Helmholtz resonating cavity. This may mean that the energy harvesting device may include a Helmholtz resonating cavity. Further, this may mean that a bluff body of the energy harvesting device may be arranged at the entrance of the Helmholtz resonating cavity to interact with the fluid flowing through the microchannel to generate a vortex fluid street, and an energy harvesting element of the energy harvesting device may be arranged to interact with the vortex fluid street to harvest energy from the fluid.

It should be appreciated that descriptions in the context of the energy harvesting device 200 may be applicable also in the context of the various methods of harvesting energy.

Various embodiments may also provide a sensing device including a microchannel arranged to receive a fluid, a bluff body arranged to interact with the fluid flowing through the microchannel to generate a vortex fluid street, and a sensing element arranged to interact with the vortex fluid street.

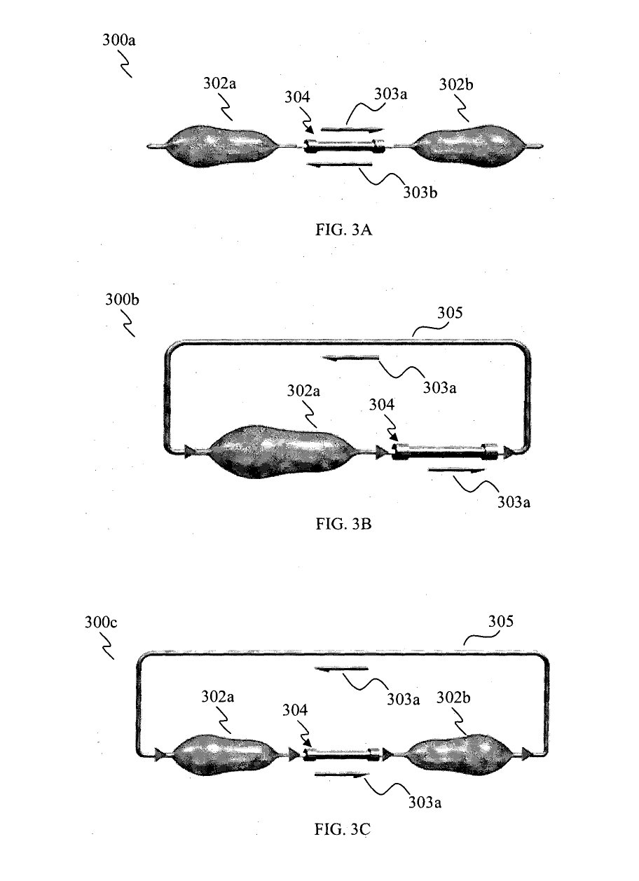

The energy harvesting system of various embodiments may include one or two modules which may store energy from pressure differential, acceleration or other source into pressurized fluid(s), as shown in FIGS. 3A to 3C. For example, each energy harvesting system 300a (FIG. 3A), 300c (FIG. 3C) may include two modules (e.g. bladders) 302a, 302b while the the energy harvesting system 300b (FIG. 3B) may include one module (e.g. a bladder) 302a. Further, the energy harvesting systems 300a, 300b, 300c may include an energy harvesting device 304 coupled to one module 302 or two modules 302a, 302b, for example between the two modules 302a, 302b. A fluid connecting path or tube 305 may also be provided. Each module 302a, 302b may eject pressurized fluid(s) uni-directionally, as represented by the arrows 303a (as shown in FIGS. 3B and 3C) or bi-directionally, as represented by the arrows 303a, 303b (as shown in FIG. 3A).

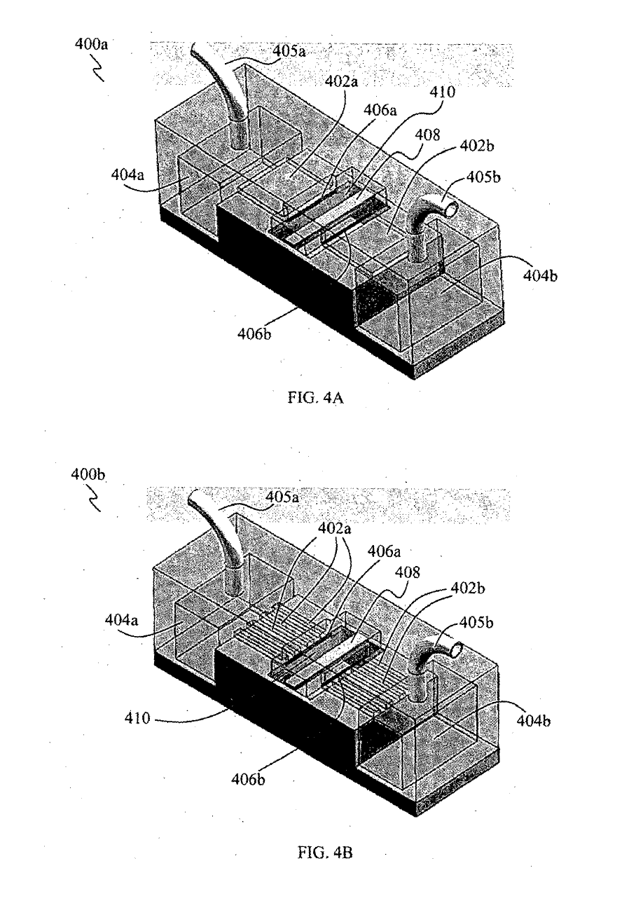

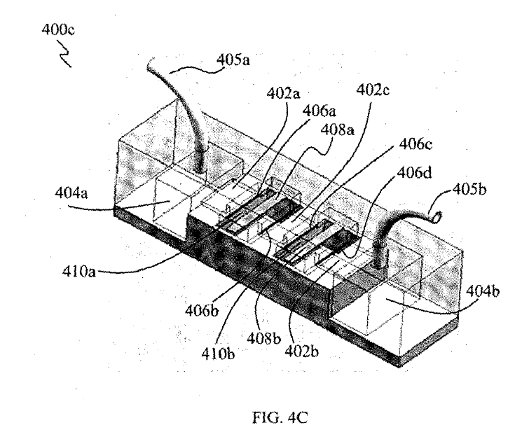

FIG. 4A shows an energy harvesting device 400a, according to various embodiments. The energy harvesting device 400a may include a first microchannel 402a and a second microchannel 402b, a first fluid container 404a in fluid communication with or coupled to the first microchannel 402a, and a second fluid container 404b in fluid communication with or coupled to the second microchannel 402b. The energy harvesting device 400a may further include a first tube 405a in fluid communication with or coupled to the first fluid container 404a, and a second tube 405b in fluid communication with or coupled to the second fluid container 404b. The energy harvesting device 400a may receive a fluid via the first tube 405a and/or the second tube 405b. The first tube 405a may for example be arranged in fluid communication with or coupled to the first module 302a, while the second tube 405b may for example be arranged in fluid communication with or coupled to the second module 302b or the fluid connecting path 305.

The energy harvesting device 400a may further include a first bluff body 406a positioned in proximity to the first microchannel 402a, for example at the exit of the first microchannel 402a opposite to the side of the first microchannel 402a in fluid communication with the first fluid container 404a, and a second bluff body 406b positioned in proximity to the second microchannel 402b, for example at the exit of the second microchannel 402b opposite to the side of the second microchannel 402b in fluid communication with the second fluid container 404b. The energy harvesting device 400a may further include an energy harvesting element (e.g. a piezoelectric micro-belt) 408. The piezoelectric micro-belt 408 may be arranged in between the first microchannel 402a and the second microchannel 402b or between the first bluff body 406a and the second bluff body 406b. The piezoelectric micro-belt 408 may be positioned in a cavity 410. The first microchannel 402a and the second microchannel 402b may be arranged in fluid communication with the cavity 410. A fluid provided to or received by the energy harvesting device 400a may flow between the first microchannel 402a, the second microchannel 402b and the cavity 410.

FIG. 4B shows an energy harvesting device 400b, according to various embodiments. The energy harvesting device 400b may be as correspondingly described in the context of the energy harvesting device 400a (FIG. 4A), except that the energy harvesting device 400b may include a plurality of first microchannels 402a and/or a plurality of second microchannels 402b. It should be appreciated that any number of the plurality of first microchannels 402a and/or plurality of second microchannels 402b may be provided, for example two, three, four or any higher number.

FIG. 4C shows an energy harvesting device 400c, according to various embodiments. The energy harvesting device 400c may include a first microchannel 402a and a second microchannel 402b, a first fluid container 404a in fluid communication with or coupled to the first microchannel 402a, and a second fluid container 404b in fluid communication with or coupled to the second microchannel 402b. The energy harvesting device 400a may further include a first tube 405a in fluid communication with or coupled to the first fluid container 404a, and a second tube 405b in fluid communication with or coupled to the second fluid container 404b. The energy harvesting device 400c may receive a fluid via the first tube 405a and/or the second tube 405b. The first tube 405a may for example be arranged in fluid communication with or coupled to the first module 302a, while the second tube 405b may for example be arranged in fluid communication with or coupled to the second module 302b or the fluid connecting path 305.

The energy harvesting device 400c may further include a first energy harvesting element (e.g. a piezoelectric micro-belt) 408a and a second energy harvesting element (e.g. a piezoelectric micro-belt) 408b. It should be appreciated that any number of energy harvesting elements may be provided, for example two, three, four or any higher number. The first piezoelectric micro-belt 408a may be positioned in a first cavity 410a while the second piezoelectric micro-belt 408b may be positioned in a second cavity 410b. The first microchannel 402a may be arranged in fluid communication with the first cavity 410a. The second microchannel 402b may be arranged in fluid communication with the second cavity 410b. The energy harvesting device 400c may further include a third microchannel 402c in fluid communication with the first cavity 410a and the second cavity 410b. This may mean that the third microchannel 402c may be arranged in between the first cavity 410a and the second cavity 410b. A fluid provided to or received by the energy harvesting device 400c may flow between the first microchannel 402a, the second microchannel 402b, the third microchannel 402c, the first cavity 410a and the second cavity 410b.

The energy harvesting device 400c may further include a first bluff body 406a positioned in proximity to the first microchannel 402a, for example at the exit of the first microchannel 402a opposite to the side of the first microchannel 402a in fluid communication with the first fluid container 404a, and a second bluff body 406b positioned in proximity to the third microchannel 402c. The first piezoelectric micro-belt 408a may be arranged in between the first microchannel 402a and the third microchannel 402c or between the first bluff body 406a and the second bluff body 406b.

The energy harvesting device 400c may further include a third bluff body 406c positioned in proximity to the third microchannel 402c, and a fourth bluff body 406d positioned in proximity to the second microchannel 402b, for example at the exit of the second microchannel 402b opposite to the side of the second microchannel 402b in fluid communication with the second fluid container 404b. The second piezoelectric micro-belt 408b may be arranged in between the second microchannel 402b and the third microchannel 402c or between the third bluff body 406c and the fourth bluff body 406d.

It should be appreciated that a plurality of first microchannels 402a and/or plurality of second microchannels 402b and/or a plurality of third microchannels 402c may be provided for the energy harvesting device 400c.

Each of the energy harvesting devices 400a, 400b, 400c may allow uni-directional or bi-directional flow of fluid through the energy harvesting devices 400a, 400b, 400c, depending on the arrangement of the energy harvesting devices 400a, 400b, 400c in any one of the configurations 300a (FIG. 3A), 300b (FIG. 3B), 300c (FIG. 3C).

Referring to FIGS. 4A to 4C, the linear velocity of the fluid exiting a module, e.g. 302a and/or 302b, may be up-regulated by a microchannel (e.g. first microchannel 402a and/or second microchannel 402b), as shown in FIGS. 4A and 4C, or multiple microchannels (e.g. plurality of first microchannels 402a and/or plurality of second microchannels 402b), as shown in FIG. 4B. Further, the energy harvesting devices of various embodiments may have one piezoelectric element (e.g. piezoelectric micro-belt 408), as shown in FIGS. 4A and 4B, or an array of piezoelectric elements (e.g. first piezoelectric micro-belt 408a and second piezoelectric micro-belt 408b), as shown in FIG. 4C, which may be coupled with bluff bodies (e.g. first bluff body 406a, second bluff body 406b, third bluff body 406c, fourth bluff body 406d). In this way, an array of energy harvesters may be provided.

The bluff bodies 406a, 406b, 406c, 406d, as part of the structural design, may be employed for generating a vortex fluid street (or vortex shedding street) and shortening the latent time of vortex shedding generations. The vortex shedding frequency may be defined by the dimensions of the bluff bodies 406a, 406b, 406c, 406d and the linear flow velocity. In various embodiments, each of he bluff bodies 406a, 406b, 406c, 406d may be a circle, a square or any other types of bluff body structures.

Miniature piezoelectric energy harvesting elements 408, 408a, 408b may be positioned in the vortex fluid street and the piezoelectric energy harvesting elements 408, 408a, 408b may generate vibrations due to vortex lift force. The bluff bodies 406a, 406b, 406c, 406d, may shorten the latent time of the vibration generation by the piezoelectric energy harvesting elements 408, 408a, 408b resulting from the vortex shedding effect. The vibration frequency of the miniature piezoelectric energy harvesting elements 408, 408a, 408b, and thereof of the energy harvesting device, may be up-converted by the vortex shedding effect. This may increase the energy harvesting efficiency of the device.

In various embodiments, each piezoelectric energy harvesting element 408, 408a, 408b may have a structure or arrangement 508 as shown by the non-limiting example in FIG. 5. The structure 508 may include a piezoelectric structure or material, for example in the form of a piezoelectric thin film 580, arranged on a substrate 584. The piezoelectric structure, for example in the form of a piezoelectric thin film 580, may be or may act as a piezoelectric resonator. The structure 508 may further include a first electrode (e.g. top electrode) 582a arranged on a first surface (e.g. top surface) of the piezoelectric thin film 580, and a second electrode (e.g. bottom electrode) 582b arranged on a second surface (e.g. bottom surface) of the piezoelectric thin film 580. The first and second surfaces of the piezoelectric thin film 580 may refer to opposite surfaces of the piezoelectric thin film 580.

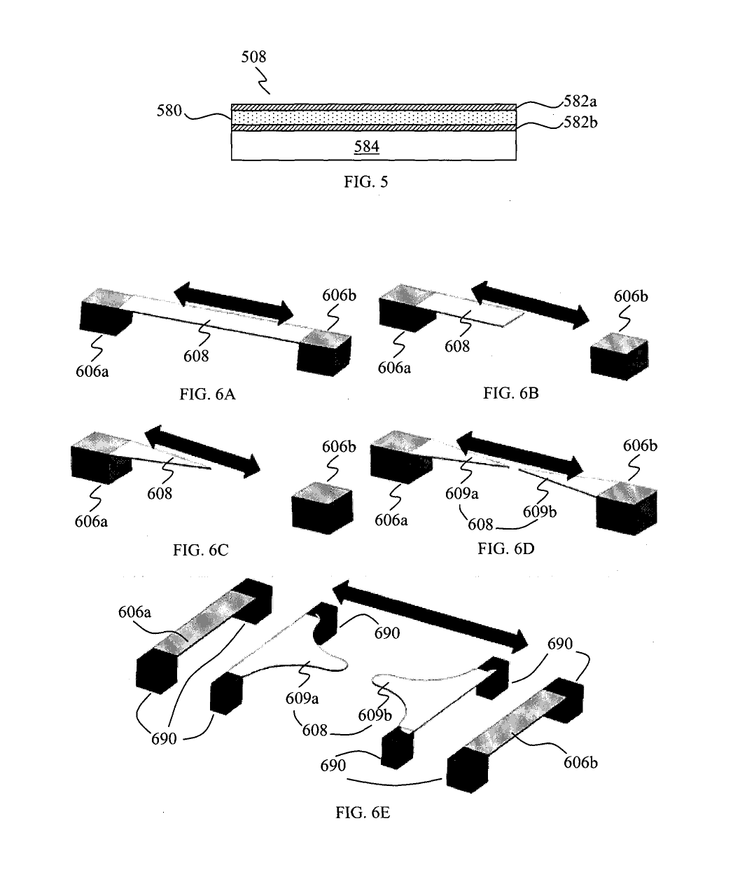

The miniaturized piezoelectric elements 408, 408a, 408b may be of various types of cantilever or clamped-clamped suspended piezoelectric/substrate beams as shown by the non-limiting examples in FIGS. 6A to 6E for a piezoelectric energy harvesting element 608. The piezoelectric energy harvesting element 608 may be or may include a cantilever beam or a double clamped beam. Further, the piezoelectric energy harvesting element 608 may be in the form of a micro-belt. In FIGS. 6A to 6E, the double-headed arrow represents the flow direction of fluid.

Referring to FIG. 6A, the piezoelectric micro-belt 608 may be coupled or clamped to bluff bodies 606a, 606b. The piezoelectric micro-belt 608 may have a quadrilateral shape (e.g. a rectangle).

Referring to FIG. 6B, the piezoelectric micro-belt 608 may be coupled or clamped to one bluff body 606a. This may mean that the piezoelectric micro-belt 608 may be or may act as a cantilever. The piezoelectric micro-belt 608 may have a quadrilateral shape (e.g. a rectangle).

Referring to FIG. 6C, the piezoelectric micro-belt 608 may be coupled or clamped to one bluff body 606a. This may mean that the piezoelectric micro-belt 608 may be or may act as a cantilever. The piezoelectric micro-belt 608 may have a triangular shape.

Referring to FIG. 6D, the piezoelectric micro-belt 608 include two portions 609a, 609b. The first portion 609a may be coupled or clamped to one bluff body 606a while the second portion 609b may be coupled or clamped to another bluff body 606b. This may mean that each of the first portion 609a and the second portion 609b may be or may act as a cantilever. Further, this may mean that the piezoelectric micro-belt 608 may be or may act as a cantilever. Each of the first portion 609a and the second portion 609b may have a triangular shape. The tips of the first portion 609a and the second portion 609b may face each other.

Referring to FIG. 6E, the piezoelectric micro-belt 608 include two portions 609a, 609b. The first portion 609a may be arranged spaced apart from one bluff body 606a while the second portion 609b may be arranged spaced apart from an additional bluff body 606b. Each of the first portion 609a and the second portion 609b may have three ends, with two of the ends coupled or clamped to anchoring structures 690. This may mean that each of the first portion 609a and the second portion 609b may be or may act as a cantilever. Further, this may mean that the piezoelectric micro-belt 608 may be or may act as a cantilever. The tips or free ends of the first portion 609a and the second portion 609b may face each other. Further, the ends of the bluff bodies 606a, 606b may be coupled or clamped to anchoring structures 690.

Each piezoelectric micro-belt 608 may be arranged with its longitudinal axis aligned at least substantially along the fluid flow direction (FIGS. 6A to 6D) or aligned at least substantially across the fluid flow direction (FIG. 6E).

When the natural frequency of the piezoelectric energy harvesting element (e.g. 408, 408a, 408b, 508, 608) is close to the vortex shedding frequency, the latter frequency may synchronize with the natural frequency; where this means that the flow is in a locked-in status. The piezoelectric energy harvesting element may vibrate at its resonance frequency by the vortex shedding lift force. The suspended flexural beams of the piezoelectric energy harvesting elements may effectively convert the vertical force due to the vibration into planar stress in the transverse direction of the piezoelectric thin film (e.g. 580), and thus, the energy harvesting device may generate electrical energy in the piezoelectric film. An electrical potential may be formed between the top and bottom electrodes (e.g. 582a, 582b) on the surfaces of the piezoelectric thin film (e.g. 580).

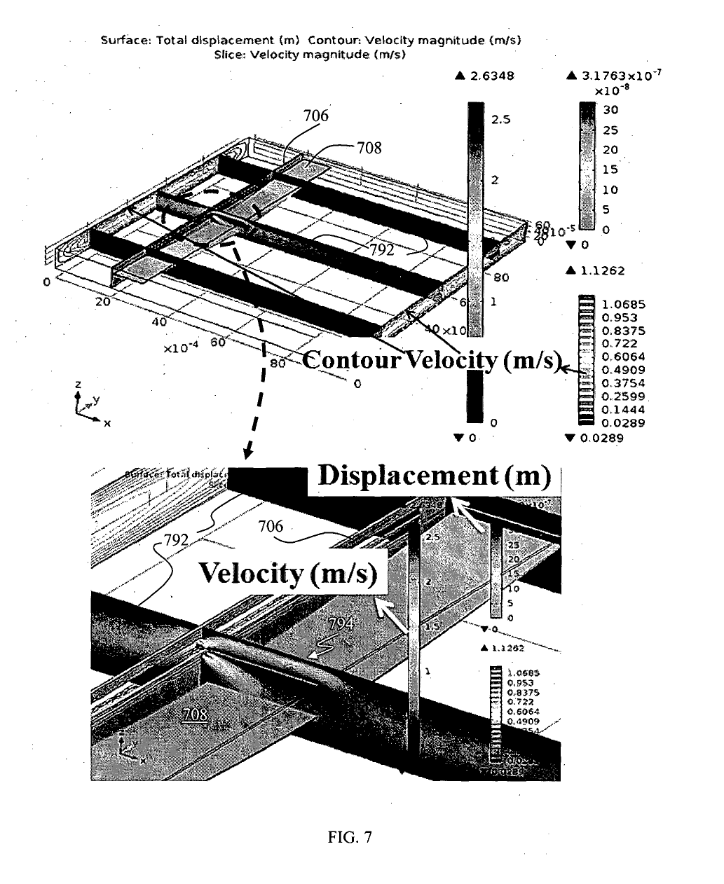

Simulation results of the energy harvesting frequency up-conversion method of various embodiments will now be described by way of the following non-limiting examples. A model of an energy harvester with a bluff body, followed by a piezoelectric micro-belt may be used. FIG. 7 shows plots of simulation results of the generated displacement of the micro-belt 708 and the distribution of the fluid linear velocity. When a fluid 792 flows past a bluff body 706, a vortex street 794 may be generated in the wake region, as shown in FIG. 7, and the periodic vortex shedding resulting from the vortex street 794 may induce periodic pressure variations on the micro-belt 708 which is positioned on the vortex street 794.

The vortex shedding frequency, f, may be expressed in a dimensionless form by the Strouhal Number St

$$f = \frac{{S}_{t} V}{D} , \qquad ( Equation 1 )$$

where V is the flow linear velocity and D is the characteristic length.

In order to optimise or maximise energy harvesting efficiency, in various embodiments, the piezoelectric micro-belt may be put or arranged on the vortex street with a natural resonant frequency fₙ. When the fluid (e.g. air) linear velocity reaches a sufficient value, and neglecting the inflow frequency, the vortex shedding frequency f may be close to the natural frequency of the energy harvester fₙ, and then the flow in the vortex street may be in a lock-in status, which may result in the energy harvester working at an optimum or maximum efficiency.

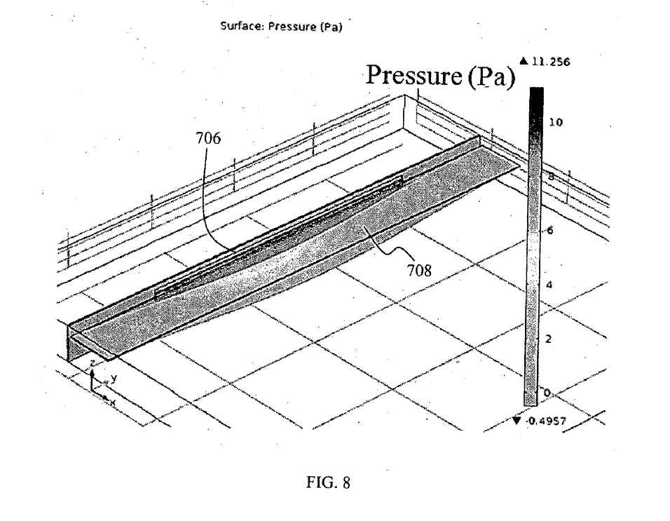

In order to study the vortex shedding effect of the energy harvester device or system of various embodiments, a static analysis relating to the relations among the displacement, the pressure distribution on the surface of the piezoelectric micro-belt with the inflow air linear velocity was carried out. FIG. 7 shows a three-dimensional (3D) simulation of the generated displacement on the piezoelectric micro-belt 708 and the air linear velocity distribution both around the bluff body 706 and the in/out of the microchannel air linear velocity. In order to maximize energy harvesting efficiency, the inflow air linear velocity may be set to about 1.5 m/s based on the vortex shedding principle and Equation 1. From FIG. 7, it may be observed that the bluff body 706 may change the air flow direction and may generate a variation of the air linear velocity on the top and bottom sides or surfaces of the piezoelectric micro-belt 708 due to the vortex effect. This may result in pressure differential on both surfaces of the piezoelectric micro-belt 708, which may be as shown in FIG. 8.

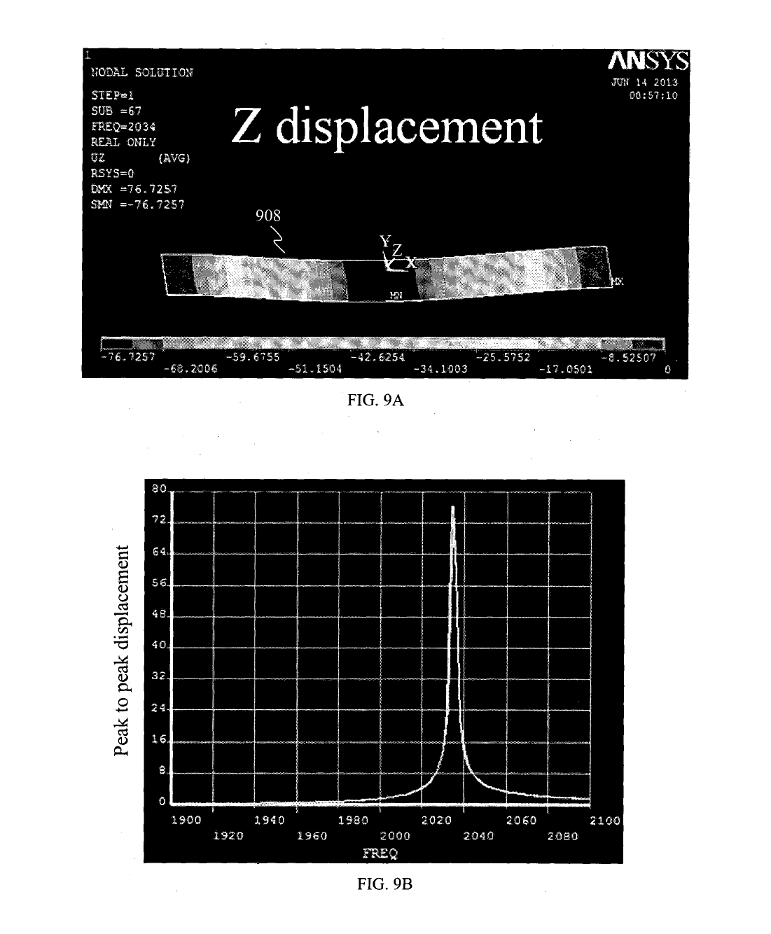

FIG. 9A shows a plot of simulation results of the displacement of the piezoelectric micro-belt 908, illustrating results of dynamic analysis of the micro-belt 908. FIG. 9B shows a plot of peak to peak displacement results for the piezoelectric micro-belt 908.

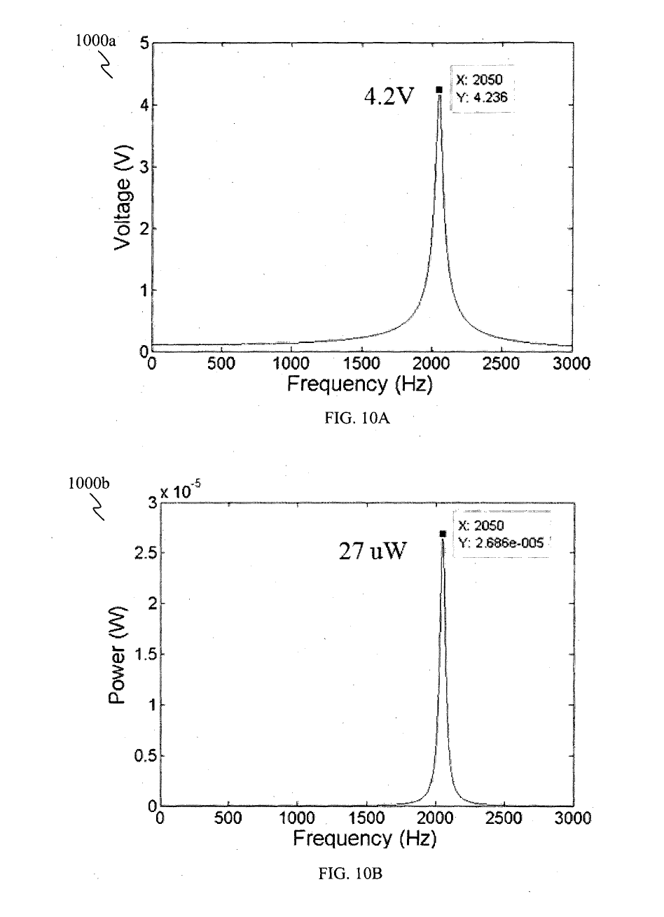

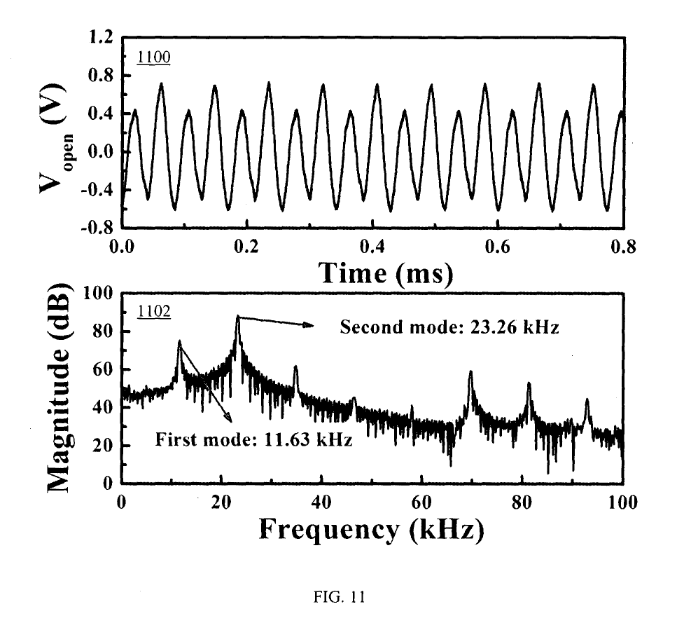

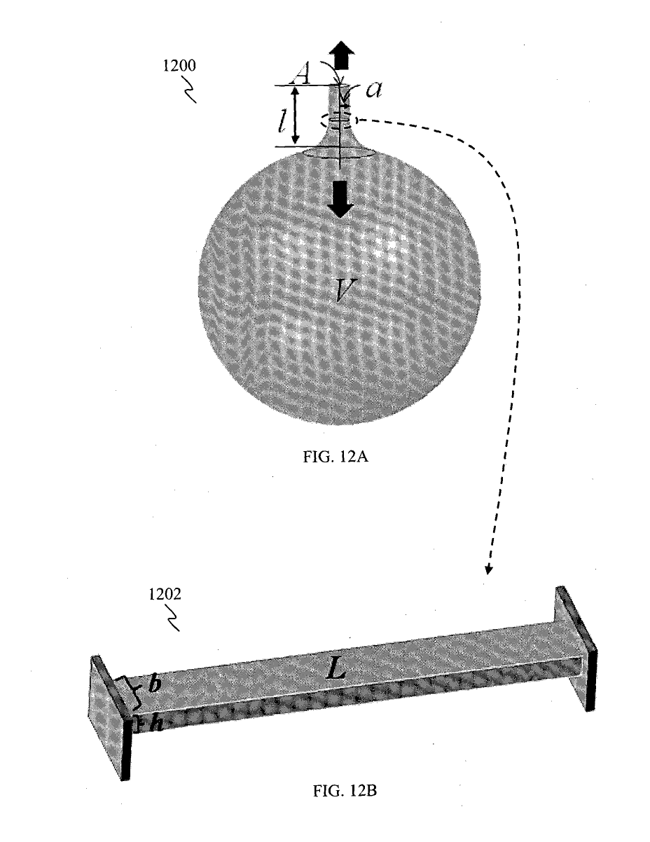

Simulation to apply the generated pressure shown in FIG. 8 on the piezoelectric micro-belt for harmonic analysis will now be described. FIGS. 10A and 10B show respective plots 1000a, 1000b of the generated open-circuit voltage and the output power of the energy harvesting device of various embodiments at an air linear velocity of about 1.5 m/s. Plot 1000a shows a maximum output voltage of about 4.24 V while plot 1000b shows a maximum output power of about 26.8 μW, at the resonant frequency, which corresponds to a lock-in status. The generated voltage and output power may be sufficient to power a wireless electronic device.

FIG. 11 shows a plot 1100 of the measurement result of the output open-circuit voltage (Vₒₚₑₙ) and a plot 1102 of the corresponding frequency spectra of the energy harvesting device of various embodiments. The results are obtained based on an energy harvesting device with a bluff body under a constant air flow at a pressure of about 4.2 psi (e.g. a flow rate of about 4 liters/min, where the generated voltage reaches maximum with a peak to peak value of about 1.4 V).

Various embodiments may further provide a miniaturization strategy for harvesting low frequency vibration energy, which may be based on Micro Electro Mechanical Systems (MEMS) technology. For example, various embodiments may provide an energy harvesting device or system with frequency up conversion and maximum power output maintaining capabilities by utilizing a vortex shedding effect enhanced Helmholtz resonator cavity mechanism.

Various embodiments may provide a miniaturization strategy for harvesting a low-frequency random vibration energy with a piezoelectric energy harvesting (EH) system or device utilizing coupled Helmholtz resonance and vortex shedding effect. As a non-limiting example, a low-frequency vibration energy may be transferred into a pressurized fluid, which in turn may be converted into a predefined, pressure-independent high-frequency energy that may be harvested by the energy harvesting device. The vibration-pressurized fluid conversion may extend the device sampling frequency band, and may enable efficient harvesting of broadband low vibration frequencies with a small form factor. In other words, the low frequency vibration energy may be transferred into a pressurized fluid, which in turn may drive a pre-defined high frequency piezoelectric energy harvesting structure (device). This may result in a high efficiency, miniature EH for a wide spectrum of low frequency applications.

The emerging trend of self-powered electronic systems creates great demand for miniature energy harvesters (EH). Current vibratory energy harvester strategies, although showing some commercial tractions, are inherently bulky and inefficient for low frequency applications (10ths˜100s Hz). This frequency versus size contradiction limits the practical use of current energy harvesters. In contrast, various embodiments may provide a CMOS process compatible vortex shedding effect enhanced Helmholtz cavity energy harvesting strategy that may eliminate or address the above-mentioned contradiction. In this strategy, a low frequency vibration energy may be transferred into a pressurized fluid, which in turn may drive a high frequency (˜10s kHz) piezoelectric energy harvesting structure. This may result in a high efficiency, miniature energy harvester for a wide spectrum of low frequency applications, for example for effectively harvesting energy from low frequency ambient sources, including medical (10ths˜10s Hz), mobile (1s˜10s Hz), automotives (10s˜4,000s Hz), and structural health monitoring (˜Hz), etc. Therefore, various embodiments may provide a direction for building a high performance, wideband, miniature energy harvester for medical, automotive, and wireless applications.

Various embodiments may relate to piezoelectric micromechanical energy harvesters for applications such as wireless network like implantable bio-sensor system, TPMS (tire pressure monitor system) and gas/oil flow monitoring system, among others. For example, various embodiments may provide development of a miniaturization strategy for harvesting low frequency energy with improved energy harvesting efficiency.

Various embodiments may provide a bluff body-energy harvesting element-Helmholtz resonating cavity structure. Helmholtz resonance is the phenomenon of air resonance in a cavity, as illustrated in FIG. 12A. The energy harvesting element may be a piezoelectric energy harvesting element. The bluff body-piezoelectric energy harvesting elements-Helmholtz resonating cavity of various embodiments may generate inlet fluid velocity/pressure-independent severe vibration (resonating) of the energy harvesting elements. Most of the energies from low frequency ambient sources may be capable of being harvested by the energy harvester structure of various embodiments with high efficiency. The bluff body may be belts, beams, pillars of various cross-sections (circular, square and rectangular etc.). The piezoelectric energy harvesting elements may be any types of easy vibrating structures (e.g. micro-belts, cantilevers, leafs and nets etc.). The energy harvesting elements may be placed in any position of the Helmholtz cavity. There may be a single Helmholtz cavity or a plurality of Helmholtz cavities of different amounts. Each Helmholtz cavity may be of any shapes. In various embodiments, at least two nozzles or microchannels may be provided, for example acting an inlets/outlets.

A Helmholtz resonator or resonating cavity 1200 may be represented as a simple mass-spring system, where the mass is the volume of the air in the neck of the resonator 1200 and the spring is the volume of the air in the cavity of the resonator 1200. The resonance frequency, f, of the cavity may depend on the volume of the cavity and the volume of the aperture (the neck or orifice) of the cavity, and may be defined as follows:

$$f = \frac{ω}{2 π} = \frac{{C}_{air}}{2 π} \sqrt{\frac{A}{{Vl}^{′}}} = \frac{{C}_{air}}{2 π} \sqrt{\frac{A}{V ( l + 1.6 a )}} , \qquad ( Equation 2 )$$

where Cₐᵢᵣ is the speed of sound in air, A is the cross sectional area of the neck (or orifice area), l′ is the apparent or effective length of the neck (or orifice), l is the actual length of the neck, a is the radius of the neck and V is the static volume of the cavity or volume of air in the resonator 1200. If the aperture is slender, then A should be considered the average cross sectional area of the neck. The apparent length of the neck includes the actual length of the neck l with correction for the extra inertial mass of air around the neck region. For a slender aperture, a is the inside radius of the neck. One or more beams or blades 1202, for example as shown in FIG. 12B, that may vibrate at “high frequencies” (typically>20 kHz) as a result of the acoustical vibration (resonance), may be provided.

Referring to FIG. 12B, the beam 1202 may have a length or span, L, a width, b, and a height, h. The natural frequency of the beam 1202 may be defined as:

$$f = \frac{1}{2 π} \sqrt{\frac{k}{M}} , \qquad ( Equation 3 )$$

where k is the equivalent stiffness and may be defined as

$$k = \frac{192 EI}{{L}^{3}} , \qquad ( Equation 4 )$$

where I is the moment inertia of beam cross section and may be defined as

$$I = \frac{{bh}^{3}}{12} , \qquad ( Equation 5 )$$

and where E is the Young's modulus of elasticity, and M is the beam mass.

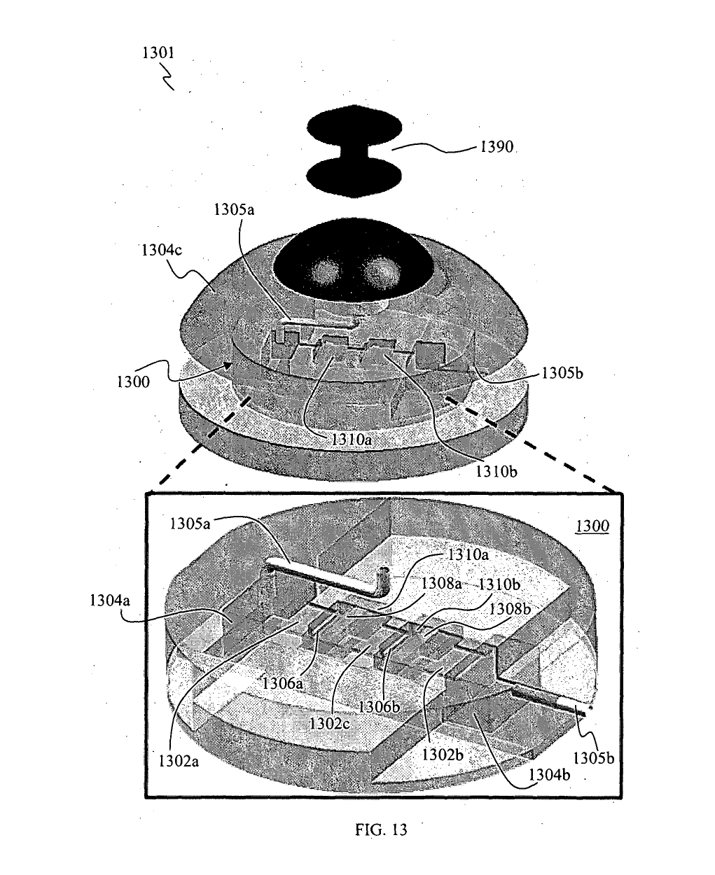

Various embodiments may provide a special or custom designed MEMS energy harvesting system with a universal operation frequency. FIG. 13 shows a schematic of an energy harvesting system 1301, according to various embodiments, illustrating a vibration-fluid-vibration energy harvester strategy. The energy harvester system 1301 may include an energy harvesting device (e.g. a micro-belt energy harvester) 1300.

The energy harvesting device 1300 may include a first microchannel 1302a and a second microchannel 1302b, a first fluid container 1304a in fluid communication with or coupled to the first microchannel 1302a, and a second fluid container 1304b in fluid communication with or coupled to the second microchannel 1302b. The energy harvesting device 1300 may further include a first tube (e.g. flow inlet tube) 1305a in fluid communication with or coupled to the first fluid container 1304a, and a second tube (e.g. flow outlet tube) 1305b in fluid communication with or coupled to the second fluid container 1304b. The energy harvesting device 1300 may receive a fluid, for example, via the first tube 1305a.

The energy harvesting device 1300 may further include a compressible fluid container 1304c which may be arranged in fluid communication with or coupled to the first tube 1305a. The energy harvester system 1301 may include a vibration source 1390 which may generate a vibratory motion that may assist in compressing the compressible fluid container 1304c to eject or cause fluid in the compressible fluid container 1304c to flow out from the compressible fluid container 1304c into the first tube 1305a and then to the first fluid container 1304a.

The energy harvesting device 1300 may further include a first energy harvesting element (e.g. a piezoelectric micro-belt) 1308a and a second energy harvesting element (e.g. a piezoelectric micro-belt) 1308b. It should be appreciated that any number of energy harvesting elements may be provided, for example two, three, four or any higher number. The first piezoelectric micro-belt 1308a may be positioned in a first Helmholtz cavity 1310a while the second piezoelectric micro-belt 1308b may be positioned in a second Helmholtz cavity 1310b. The first microchannel 1302a may be arranged in fluid communication with the first Helmholtz cavity 1310a. The second microchannel 1302b may be arranged in fluid communication with the second Helmholtz cavity 1310b. The energy harvesting device 1300 may further include a third microchannel 1302c in fluid communication with the first Helmholtz cavity 1310a and the second Helmholtz cavity 1310b. This may mean that the third microchannel 1302c may be arranged in between the first Helmholtz cavity 1310a and the second Helmholtz cavity 1310b. The first piezoelectric micro-belt 1308a may be arranged in between the first microchannel 1302a and the third microchannel 1302c. The second piezoelectric micro-belt 1308b may be arranged in between the second microchannel 1302b and the third microchannel 1302c. A fluid provided to or received by the energy harvesting device 1300 may flow between the first microchannel 1302a, the second microchannel 1302b, the third microchannel 1302c, the first Helmholtz cavity 1310a and the second Helmholtz cavity 1310b.

The energy harvesting device 1300 may further include a first bluff body 1306a positioned in proximity to the first microchannel 1302a, for example at the exit of the first microchannel 1302a opposite to the side of the first microchannel 1302a in fluid communication with the first fluid container 1304a.

The energy harvesting device 1300 may further include a second bluff body 1306b positioned in proximity to the third microchannel 1302c, for example at the exit of the third microchannel 1302c.

It should be appreciated that a plurality of first microchannels 1302a and/or plurality of second microchannels 1302b and/or a plurality of third microchannels 1302c may be provided for the energy harvesting device 1300, which may be as correspondingly described in the context of the energy harvesting device 400b (FIG. 4B).

As described above, energy harvester system 1301 may include a compressible fluid container 1304c coupled with microchannels 1302a, 1302b, 1302c, bluff body(s) 1306a, 1306b, functional elements (or energy harvesting elements), for example in the form of piezoelectric micro-belts 1308a, 1308, and Helmholtz resonating cavities 1310a, 1310b. It should be appreciated that piezoelectric micro-blades, micro-cantilevers or other structures may be provided for the energy harvesting elements. The functional piezoelectric elements play a part in harvesting energy. The compressible fluid container 1304c may be capable of transferring external vibratory motion (e.g. generated by the vibration source 1390) to the pressurized constant inlet flow, which is in turn accelerated by each microchannel 1302a, 1302b, 1302c. A vortex shedding effect may then be induced by each bluff body 1306a, 1306b which may be placed in front of a respective energy harvesting element 1308a, 1308b. This may mean that each bluff body 1306a, 1306b may generate a vortex fluid street. The vortex shedding effect may help the fluid flow to generate resonance in each Helmholtz cavity 1310a, 1310b. In other words, the Helmholtz cavities 1310a, 1310b may be resonating. The vibration of the energy harvesting elements 1308a, 1308b may be governed by this resonance, and the resonating frequency may be independent of inlet flow velocity and frequency. The maximum output power may be harvested when the natural frequency of the energy harvesting elements 1308a, 1308b is at least substantially matched to that of the Helmholtz resonating cavity 1310a, 1310b. Therefore, the energy harvesting device 1300 and therefore also the energy harvester system 1301 may enable pressurized fluid(s) to be injected and ejected uni-, bi-directionally or even multi-directionally from a low frequency source.

Accordingly, the energy harvesting device of various embodiments may include specific energy harvesting module(s) which may include microchannel(s), bluff body(s), energy harvesting element(s) (e.g. piezoelectric micro-belts etc) and one or more Helmholtz resonating cavities. In order to miniaturize the energy harvester system, an inlet nozzle-cavity-outlet nozzle like structure may be utilised, for example as shown in FIG. 13, where the nozzle refers to the microchannel. Pressurized fluids originating from external low frequency sources of pressure differential, acceleration or other cases, may be forced to be injected and ejected through the energy harvester cavity (e.g. 1310a, 1310b) uni- or bi-directionally. Microchannels' design in the nozzle area may be used to accelerate fluid flow. Cavity thickness asymmetrically arranged bluff bodies, which may be placed between the inlet nozzle and energy harvesting element(s), may assist the energy harvesting elements to start vibrating rapidly due to fluid vortex shedding effect. The vortex shedding effect may in turn generate a secondary stronger fluid vibration in the whole energy harvester cavity (Helmholtz resonating cavity). The mechanical energy may be converted to electrical energy by piezoelectric coupling co-effect.

Therefore, the inlet flow speed may be accelerated by a narrow nozzle or microchannel, which works together with one or more bluff body(ies) to generate a vortex shedding street that may help to initiate Helmholtz resonance. Miniature piezoelectric energy harvesting element(s) may be placed in a Helmholtz resonating cavity and vibration of the piezoelectric energy harvesting element(s) may be enhanced by the Helmholtz resonating-caused force. The operating frequency of the piezoelectric energy harvesting element(s) and the energy harvesting device may be pre-defined by the Helmholtz resonating cavity and independent of inlet flow velocity and pressure. The maximum vibration of the miniature energy harvesting elements may be obtained when its natural frequency is at least substantially matched to that of the Helmholtz resonating cavity.

The resonance frequency, f, of the Helmholtz cavity of various embodiments may be defined as:

$$f = \frac{c}{2 π} \sqrt{\frac{{na}_{o} {b}_{o}}{V ( {l}_{o} + 1.6 {r}_{o} )}} , where {r}_{o} = \sqrt{\frac{{na}_{o} {b}_{o}}{π}} , \qquad ( Equation 6 )$$

where c is the speed of sound, n is the number of microchannels (which may define the orifice of the Helmholtz cavity), lₒ is the length of the orifice, V is the volume of the Helmholtz cavity, and rₒ is defined by aₒ and bₒ which are the width and height of the microchannel (which for example may be rectangularly shaped). From Equation (6), it may be seen that the resonant frequency, f, is independent of input flow rate.

In various embodiments, each energy harvesting element may include a piezoelectric material. The piezoelectric material may be any kinds of piezoelectric material such as aluminium nitride (AlN), zinc oxide (ZnO), lithium niobate (LiNbO3), or lead zirconium titanate (PZT) or any other piezoelectric materials. A substrate may be provided with the piezoelectric material. The energy harvesting element or a piezoelectric/substrate structure may be any types of micro-belts, micro-wires, micro-nets, micro-rings, micro-leafs/butterfly wing or micro-cantilevers of various shapes, or other types of structures and/or shapes may also be suitable. The miniature piezoelectric energy harvesting element(s) may work as a device sensing layer. The substrate may be any kind of solid materials such as silicon (Si), copper (Cu), aluminium (Al) or other suitable solid materials. Each bluff body may be any kind of structures such as a micro-belt, a micro-tube or a micro-wire of any possible shapes. Other types of structures and/or shapes may be employed for the bluff body. Each Helmholtz cavity may be of any shape, such as cylindrical, cubic, cuboid, or any other shapes. Each energy harvesting device may include any number of Helmholtz cavity, for example one, two, three, four or any higher number, e.g. a single cavity, a cavity array or a cavity matrix.

In various embodiments, the harvesting frequency of the energy harvester may be up-converted and governed by the Helmholtz resonating cavity. The bluff body, which may be placed in front of one or more energy harvesting element(s), may shorten the time of vortex shedding generation, and in turn may induce the whole Helmholtz cavity to resonate.

As described herein, the energy harvesting device of various embodiments may include a Helmholtz resonate cavity with an orifice, a narrow beam shaped, bluff body and a piezoelectric microbelt. The orifice may include one or multiple parallel microchannels to accelerate the input flow rate. When the fluid flows through the Helmholtz cavity, it may be partially trapped in the Helmholtz cavity and excited to resonate at the Helmholtz resonating frequency determined by cavity dimensions. This resonating fluid may induce a force on the piezoelectric micro-belt, causing it to vibrate, thus generating a strain-dependent charge output. The bluff body may be placed at the entrance of the Helmholtz cavity to enhance the Helmholtz resonance as well as the resultant charge output by the vortex shedding effect, which may also lower the threshold input pressure.

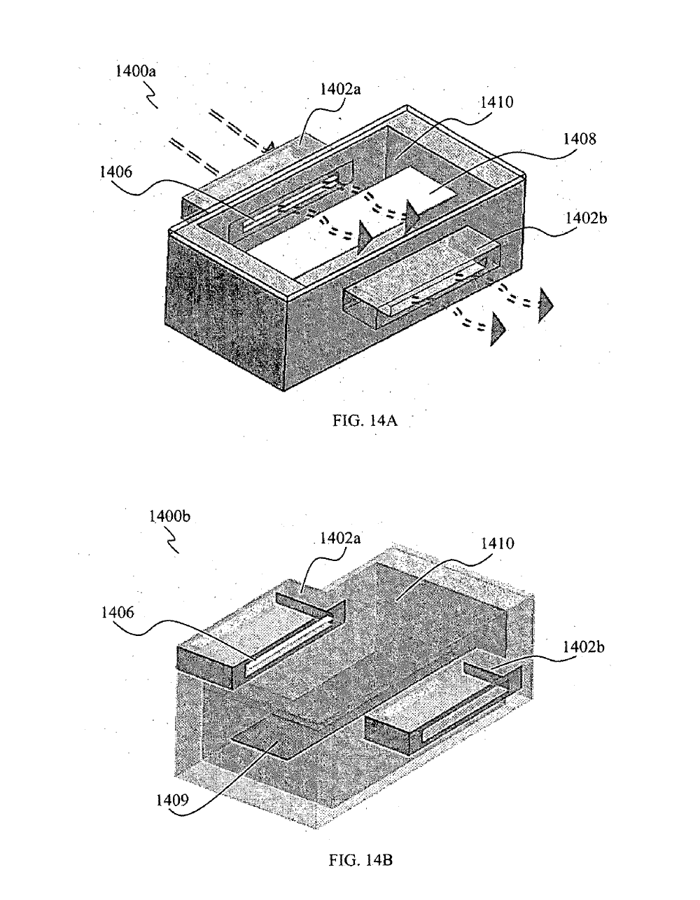

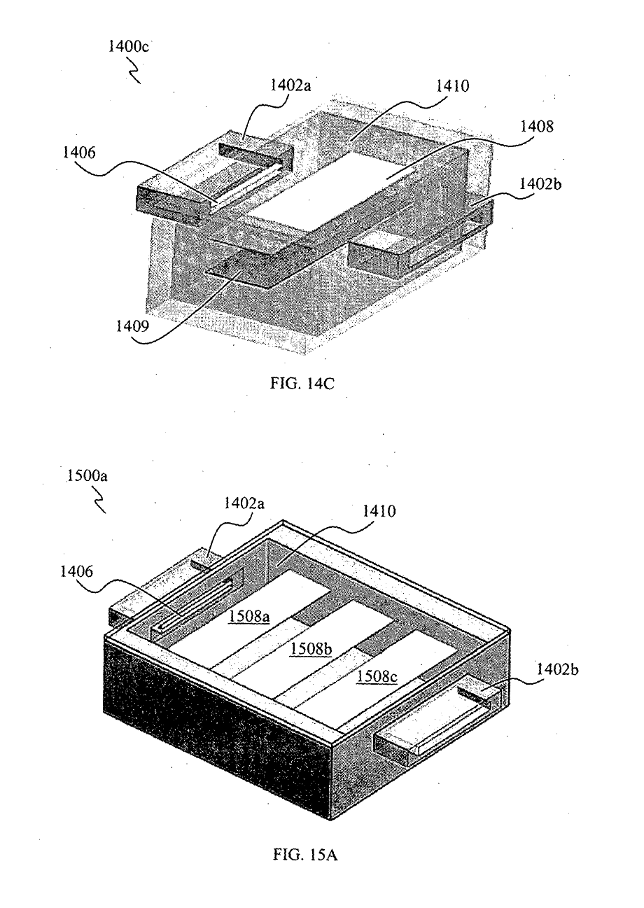

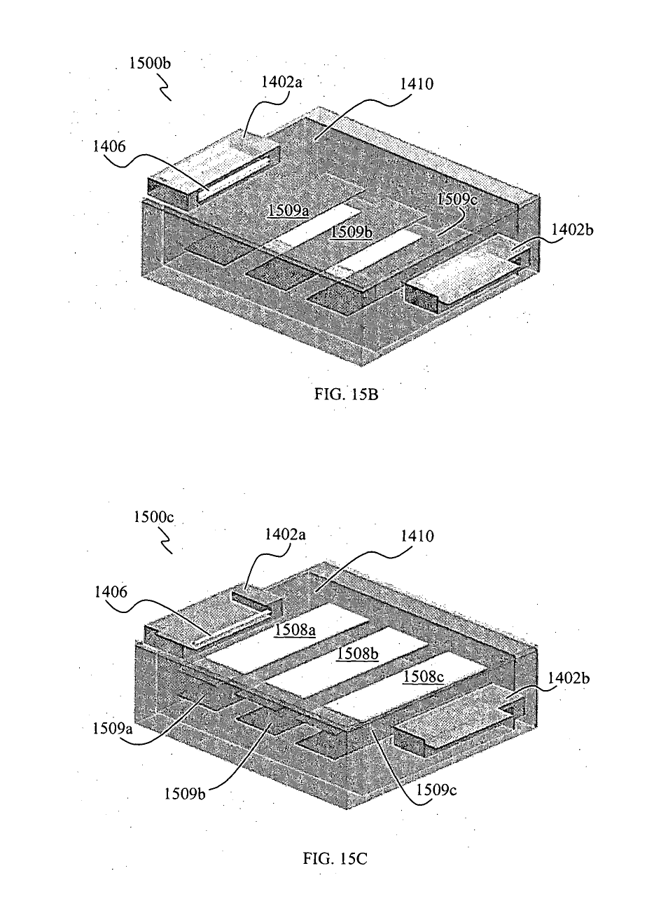

The energy harvesting device of various embodiments may have an arrangement of nozzle-bluff body-functional elements-cavity-nozzle structure of various elements, for example as shown in FIG. 14A, which may harvest energy from external low frequency sources of pressure differential, acceleration or other cases.

For a traditional one nozzle Helmholtz resonating cavity, the functional elements or energy harvesting elements are restricted in the area near the nozzle (neck), which limits the energy harvesting efficiency. In this way, the kinetic energy of the fluid (e.g. air) concentrate in the neck area, which limits utilization of the functional elements. Further, the fluid flows in and out through the same nozzle. In order to take advantage of the cavity space, a nozzle-cavity-nozzle structure (e.g. two-nozzle fluidic cavity) has also been employed, with the functional element arranged in the cavity. Fluid may flow from one nozzle towards and through the other nozzle. Such a structure may provide a laminar flow in the cavity. Turbulence flow is not likely to be generated in the microscale cavity, as the laminar flow input cannot lead to drastic vibration of the functional elements. Turbulence occurs only under an extra large inlet flow rate that is converted from a low frequency surrounding source by a sophisticated designed narrow inlet nozzle, which may directly induce an intense vibration of the functional elements. In such a case, the operating frequency imay be solely determined by the cavity size. Thus, in various embodiments, bluff bodies, the precursor of vortex shedding effect, may be placed in front of functional elements or energy harvesting elements to help to generate vibration, as illustrated in FIG. 14A for a nozzle-bluff body-energy harvesting element-cavity-nozzle (e.g. bluff body enhanced two nozzle Helmholtz resonating cavity) energy harvester 1400a. Vortex shedding induced by the bluff body may help to initiate Helmholtz resonating and may transmit maximum kinetic energy to the functional elements or energy harvesting elements.

The energy harvesting device of various embodiments may have a specific structure: inlet nozzle (or microchannel)-bluff bodies-functional elements (or energy harvesting elements)-Helmholtz resonating cavity-outlet nozzle (or microchannel). Piezoelectric functional element(s) or energy harvesting element(s) may be placed in the huge fluid cavity to capture energies.

FIG. 14A shows an energy harvesting device 1400a, according to various embodiments. The energy harvesting device 1400a may include a first microchannel 1402a (or first nozzle) and a second microchannel 1402b (or second nozzle). While not shown, the energy harvesting device 1400a may include a first fluid container in fluid communication with or coupled to the first microchannel 1402a, and a second fluid container in fluid communication with or coupled to the second microchannel 1402b.

The energy harvesting device 1400a may further include a bluff body 1406 positioned in proximity to the first microchannel 1402a, for example at the exit of the first microchannel 1402a. The energy harvesting device 1400a may further include an energy harvesting element (e.g. a piezoelectric micro-belt) 1408. The piezoelectric micro-belt 1408 may be arranged in between the first microchannel 1402a and the second microchannel 1402b. The energy harvesting element 1408 may be positioned in a Helmholtz cavity 1410, for example towards an upper region (top region) of the cavity Helmholtz cavity 1410. Therefore, the energy harvesting element 1408 may be an upper layer energy harvesting element. The first microchannel 1402a and the second microchannel 1402b may be arranged in fluid communication with the Helmholtz cavity 1410. A fluid provided to or received by the energy harvesting device 1400a may flow between the first microchannel 1402a, the second microchannel 1402b and the Helmholtz cavity 1410. For example, as illustrated in FIG. 14A, a fluid may flow in a direction from the first microchannel 1402a and the bluff body 1406, towards the energy harvesting element 1408, the Helmholtz cavity 1410 and the second microchannel 1402b, as illustrated by the dashed arrows.

It should be appreciated that a plurality of first microchannels 1402a and/or plurality of second microchannels 1402b may be provided for the energy harvesting device 1400a, which may be as correspondingly described in the context of the energy harvesting device 400b (FIG. 4B).

FIG. 14B shows an energy harvesting device 1400b, according to various embodiments. The energy harvesting device 1400b may be as correspondingly described in the context of the energy harvesting device 1400a (FIG. 14A), except that the energy harvesting device 1400b may include an energy harvesting element (e.g. a piezoelectric micro-belt) 1409 that may be arranged towards a lower region (bottom region) of the Helmholtz cavity 1410. Therefore, the energy harvesting element 1409 may be a lower layer energy harvesting element.

FIG. 14C shows an energy harvesting device 1400c, according to various embodiments. The energy harvesting device 1400c may be a hybrid or combination of the energy harvesting devices 1400a, 1400b, meaning that the energy harvesting device 1400c may include an energy harvesting element (e.g. a piezoelectric micro-belt) 1408 that may be arranged towards an upper region (top region) of the Helmholtz cavity 1410, and another energy harvesting element (e.g. a piezoelectric micro-belt) 1409 that may be arranged towards a lower region (bottom region) of the Helmholtz cavity 1410. Therefore, the energy harvesting element 1408 may be an upper layer energy harvesting element while the energy harvesting element 1409 may be a lower layer energy harvesting element.

As would be appreciated, the energy harvesting devices 1400a, 1400b, 1400c may have one or more laterally arranged energy harvesting elements 1408, 1409, meaning that the energy harvesting elements 1408, 1409 may be arranged in a lateral orientation of the fluid flow of a single energy harvesting element or multiple energy harvesting elements arranged along a thickness direction of the Helmholtz cavity 1410.

FIG. 15A shows an energy harvesting device 1500a, according to various embodiments. The energy harvesting device 1500a may be as correspondingly described in the context of the energy harvesting device 1400a (FIG. 14A), except that the energy harvesting device 1500a may include a plurality or array of energy harvesting elements (e.g. piezoelectric micro-belts) 1508a, 1508b, 1508c arranged one after the other in the flow direction, within the Helmholtz cavity 1410. The energy harvesting elements 1508a, 1508b, 1508c may be arranged spaced apart from each other. It should be appreciated that any number of energy harvesting elements may be provided, for example two, three, four, five or any higher number. The energy harvesting elements 1508a, 1508b, 1508c may be arranged towards an upper region (top region) of the cavity Helmholtz cavity 1410. Therefore, the energy harvesting elements 1508a, 1508b, 1508c may be upper layer energy harvesting elements.

FIG. 15B shows an energy harvesting device 1500b, according to various embodiments. The energy harvesting device 1500b may be as correspondingly described in the context of the energy harvesting device 1500a (FIG. 15A), except that the energy harvesting device 1500b may include a plurality or array of energy harvesting elements (e.g. piezoelectric micro-belts) 1509a, 1509b, 1509c that may be arranged towards a lower region (bottom region) of the Helmholtz cavity 1410. Therefore, the energy harvesting elements 1509a, 1509b, 1509c may be lower layer energy harvesting elements.

FIG. 15C shows an energy harvesting device 1500c, according to various embodiments. The energy harvesting device 1500c may be a hybrid or combination of the energy harvesting devices 1500a, 1500b, meaning that the energy harvesting device 1500c may include a plurality or array of energy harvesting elements 1508a, 1508b, 1508c that may be arranged towards an upper region (top region) of the Helmholtz cavity 1410, and a plurality or array of energy harvesting elements 1509a, 1509b, 1509c that may be arranged towards a lower region (bottom region) of the Helmholtz cavity 1410. Therefore, the energy harvesting elements 1508a, 1508b, 1508c may be upper layer energy harvesting elements while the energy harvesting elements 1509a, 1509b, 1509c may be lower layer energy harvesting elements.

As would be appreciated, the energy harvesting devices 1500a, 1500b, 1500c may include an array of energy harvesting elements 1508a, 1508b, 1508c, and/or 1509a, 1509b, 1509c arranged in a single cavity 1410. Each energy harvesting device 1500a, 1500b, 1500c may include a laterally arranged energy harvesting element array.

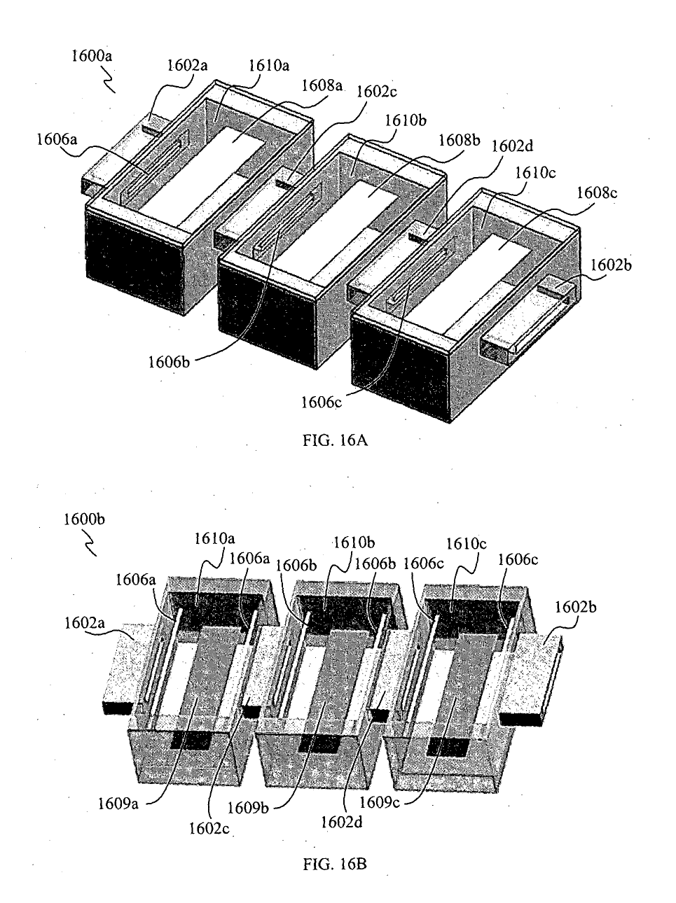

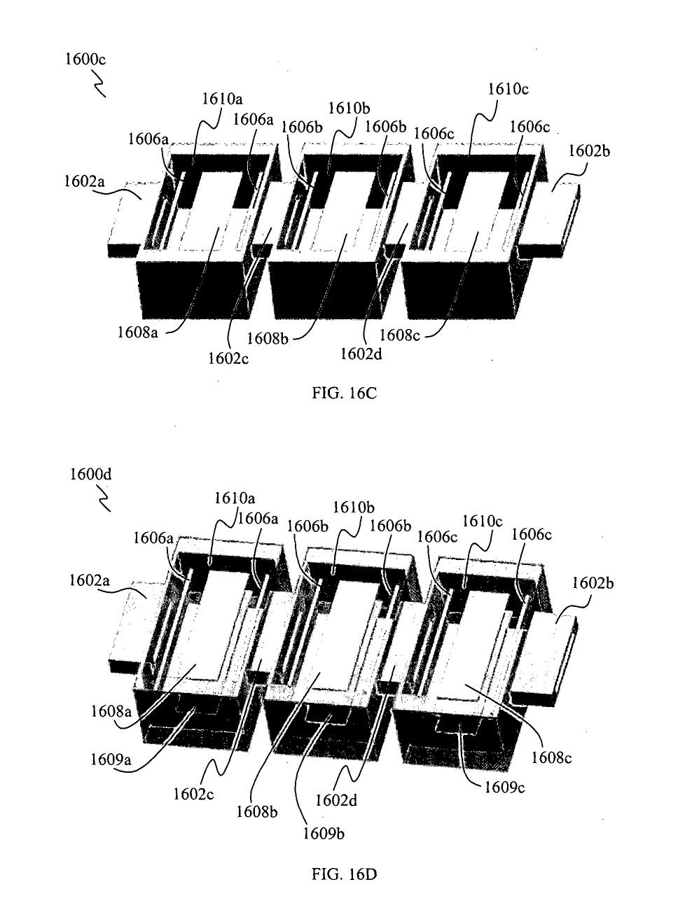

FIG. 16A shows an energy harvesting device 1600a, according to various embodiments. The energy harvesting device 1600a may include a first microchannel 1602a and a second microchannel 1602b. While not shown, the energy harvesting device 1600a may include a first fluid container in fluid communication with or coupled to the first microchannel 1602a, and a second fluid container in fluid communication with or coupled to the second microchannel 1602b.

The energy harvesting device 1600a may further include an energy harvesting element (e.g. a piezoelectric micro-belt) 1608a positioned in a first Helmholtz cavity 1610a, an energy harvesting element (e.g. a piezoelectric micro-belt) 1608b positioned in a second Helmholtz cavity 1610b, and an energy harvesting element (e.g. a piezoelectric micro-belt) 1608c positioned in a third Helmholtz cavity 1610c. The energy harvesting elements 1608a, 1608b, 1608c may be arranged towards an upper region (top region) of the respective Helmholtz cavities 1610a, 1610b, 1610c. Therefore, the energy harvesting elements 1608a, 1608b, 1608c may be upper layer energy harvesting elements.

The first microchannel 1602a may be arranged in fluid communication with the first Helmholtz cavity 1610a, and the second microchannel 1602b may be arranged in fluid communication with the second Helmholtz cavity 1610b.

The energy harvesting device 1600a may further include a third microchannel 1602c in fluid communication with the first Helmholtz cavity 1610a and the second Helmholtz cavity 1610b. This may mean that the third microchannel 1602c may be arranged in between the first Helmholtz cavity 1610a and the second Helmholtz cavity 1610b.

The energy harvesting device 1600a may further include a fourth microchannel 1602d in fluid communication with the second Helmholtz cavity 1610b and the third Helmholtz cavity 1610c. This may mean that the fourth microchannel 1602d may be arranged in between the second Helmholtz cavity 1610b and the third Helmholtz cavity 1610c.

The energy harvesting device 1600b may further include a first bluff body 1606a positioned in proximity to the first microchannel 1602a, for example at the exit of the first microchannel 1602a, a second bluff body 1606b positioned in proximity to the third microchannel 1602c, for example at the exit of the third microchannel 1602c, and a third bluff body 1606c positioned in proximity to the fourth microchannel 1602d, for example at the exit of the fourth microchannel 1602d.

It should be appreciated that a plurality of first microchannels 1602a and/or a plurality of second microchannels 1602b and/or a plurality of third microchannels 1602c and/or a plurality of fourth microchannels 1602d may be provided for the energy harvesting device 1600a, which may be as correspondingly described in the context of the energy harvesting device 400b (FIG. 4B).

It should be appreciated that a plurality of energy harvesting elements may be arranged in one or more of the cavities 1610a, 1610b, 1610c, for example as may be correspondingly described in the context of the energy harvesting device 1500a.

FIG. 16B shows an energy harvesting device 1600b, according to various embodiments. The energy harvesting device 1600b may be as correspondingly described in the context of the energy harvesting device 1600a (FIG. 16A), except that the energy harvesting device 1600b may include an energy harvesting element (e.g. a piezoelectric micro-belt) 1609a positioned towards a lower region (bottom region) of the first Helmholtz cavity 1610a, an energy harvesting element (e.g. a piezoelectric micro-belt) 1609b positioned towards a lower region (bottom region) of the second Helmholtz cavity 1610b, and an energy harvesting element (e.g. a piezoelectric micro-belt) 1609c positioned towards a lower region (bottom region) of the third Helmholtz cavity 1610c. Therefore, the energy harvesting elements 1609a, 1609b, 1609c may be lower layer energy harvesting elements.

Further, the energy harvesting device 1600b may include a plurality of first bluff bodies 1606a arranged in the first Helmholtz cavity 1610a on opposite sides of the first energy harvesting element 1609a and spaced apart from the first microchannel 1602a and the third microchannel 1602c, a plurality of second bluff bodies 1606b arranged in the second Helmholtz cavity 1610b on opposite sides of the second energy harvesting element 1609b and spaced apart from the third microchannel 1602c and the fourth microchannel 1602d, and a plurality of third bluff bodies 1606c arranged in the third Helmholtz cavity 1610c on opposite sides of the third energy harvesting element 1609c and spaced apart from the fourth microchannel 1602d and the second microchannel 1602b.

It should be appreciated that a plurality of energy harvesting elements may be arranged in one or more of the cavities 1610a, 1610b, 1610c, for example as may be correspondingly described in the context of the energy harvesting device 1500b.

FIG. 16C shows an energy harvesting device 1600c, according to various embodiments. The energy harvesting device 1600c may be as correspondingly described in the context of the energy harvesting device 1600b (FIG. 16B), except that the energy harvesting device 1600c may include an energy harvesting element (e.g. a piezoelectric micro-belt) 1608a positioned towards an upper region (top region) of the first Helmholtz cavity 1610a, an energy harvesting element (e.g. a piezoelectric micro-belt) 1608b positioned towards an upper region (top region) of the second Helmholtz cavity 1610b, and an energy harvesting element (e.g. a piezoelectric micro-belt) 1608c positioned towards an upper region (top region) of the third Helmholtz cavity 1610c. Therefore, the energy harvesting elements 1608a, 1608b, 1608c may be upper layer energy harvesting elements.

It should be appreciated that a plurality of energy harvesting elements may be arranged in one or more of the cavities 1610a, 1610b, 1610c, for example as may be correspondingly described in the context of the energy harvesting device 1500a.

FIG. 16D shows an energy harvesting device 1600d, according to various embodiments. The energy harvesting device 1600d may be a hybrid or combination of the energy harvesting devices 1600b, 1600c, meaning that the energy harvesting device 1600d may include energy harvesting elements 1608a, 1609a in the first Helmholtz cavity 1610a, energy harvesting elements 1608b, 1609b in the second Helmholtz cavity 1610b, and energy harvesting elements 1608c, 1609c in the third Helmholtz cavity 1610c. The energy harvesting elements 1608a, 1608b, 1608c may be upper layer energy harvesting elements, while the energy harvesting elements 1609a, 1609b, 1609c may be lower layer energy harvesting elements.

It should be appreciated that a plurality of energy harvesting elements may be arranged in one or more of the cavities 1610a, 1610b, 1610c, for example as may be correspondingly described in the context of the energy harvesting device 1500c.

As would be appreciated, the energy harvesting devices 1600a, 1600b, 1600c, 1600d may include a plurality or array of Helmholtz cavities 1610a, 1610b, 1610c which may be arranged in fluid communication with each other. It should be appreciated that any number of Helmholtz cavities may be provided, for example two, three, four or any higher number.

As described above, the energy harvesting device of various embodiments may be a single cavity-single belt device, a single cavity-multiple belt device, a multiple cavity-single belt device or a multiple cavity-multiple belt device. The energy harvesting or functional micro-belt(s) may be placed in any position of the cavity. The maximum power output may be obtained by optimizing the micro-belt design and the position arrangement. The frequency of the micro-belt may be at least substantially matched to that of the Helmholtz cavity to obtain the maximum power generation.

Further, single or multiple micro-belts may be placed in a down-flow orientation of the cavity, for example as shown in FIGS. 16A to 16D. The down-flow positioned micro-belt(s) may be placed in any position of the cavity. The maximum power output may be obtained by optimizing the micro-belt design and the position arrangement.

The bluff bodies may be an important part of the MEMS energy harvesting devices of various embodiments. In various embodiments, each of he bluff bodies may be a circle, a square or any other shapes with various arrangements.

Miniature piezoelectric energy harvesting elements may be positioned in the vortex fluid street that may be induced by the bluff bodies, and the piezoelectric energy harvesting elements may start vibrating due to vortex lift force. Simultaneously, this vibration may be further enhanced by the Helmholtz resonant effect in the big cavity. For example, the vibration of the energy harvesting elements may be dominated by the Helmholtz resonance. When the natural frequency (largest deformation modes) of the piezoelectric energy harvesting elements may be at least substantially close to the frequencies of the Helmholtz resonance, frequency synchronization may occur, and a locked-in flow status may be attained.

Simulation and measurement results of the energy harvesting strategy of various embodiments will now be described by way of the following non-limiting examples.

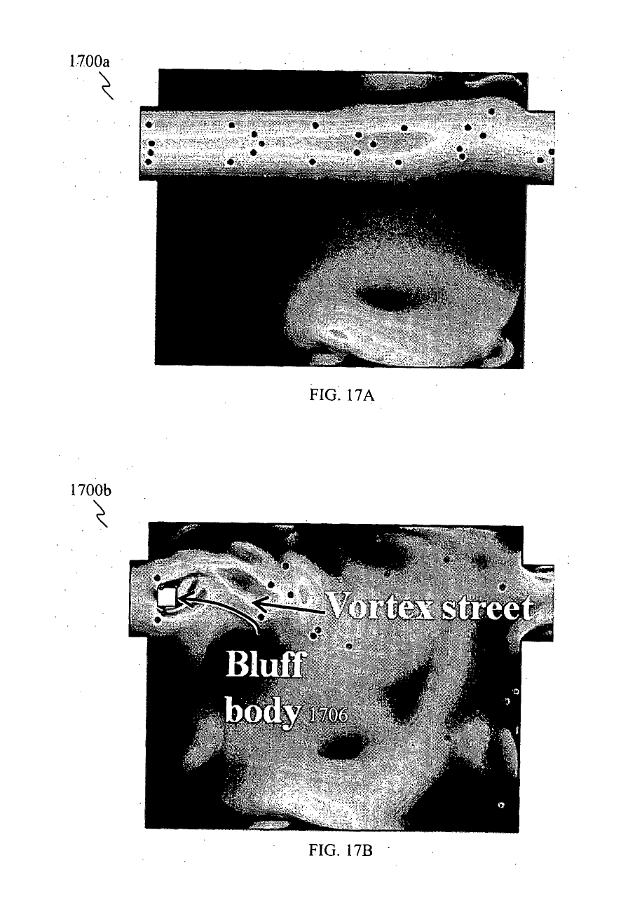

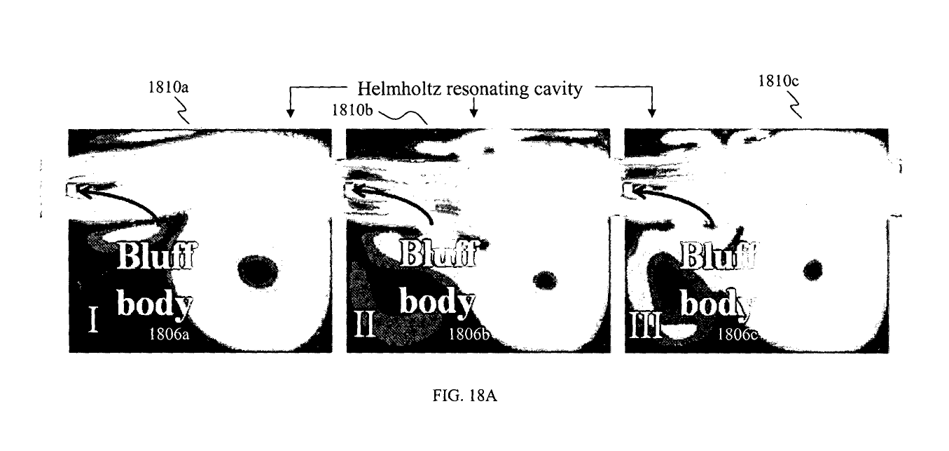

FIG. 17A shows a plot 1700a of simulated fluid behaviour in a Helmholtz resonating cavity (e.g. a micro-scaled cavity) without a bluff body while FIG. 17B shows a plot 1700b of simulated fluid behaviour in a Helmholtz resonating cavity (e.g. a micro-scaled cavity) with a bluff body 1706, illustrating the fluid behaviour of the flow-induced energy harvesting in cavities. The fluid behaviour in a Helmholtz resonating cavity without a bluff body may be a laminar flow and having the parameters: u=100 m/s, L=200 μm, v=15.68 m²/s×10⁻⁶, and Re=uL/v=1276. The parameters u, L, v and Re respectively refer to the mean velocity of the fluid, the diameter of the orifice, the air kinematic viscosity and the Reynolds number. Compared to the laminar flow in a non-bluff body micro-scaled cavity, as shown in FIG. 17A, a strong turbulent flow may be generated in the same cavity when a bluff body 1706 is present, as shown in FIG. 17B. Helmholtz resonance may be enhanced by the vortex shedding effect, induced by the vortex street. The fluid behaviour in a Helmholtz resonating cavity with a bluff body may include a transition range to turbulence in vortex and having the parameters: u=100 m/s, L=20 μm, v=15.68 m²/s×10⁻⁶, and Re=uL/v=128.

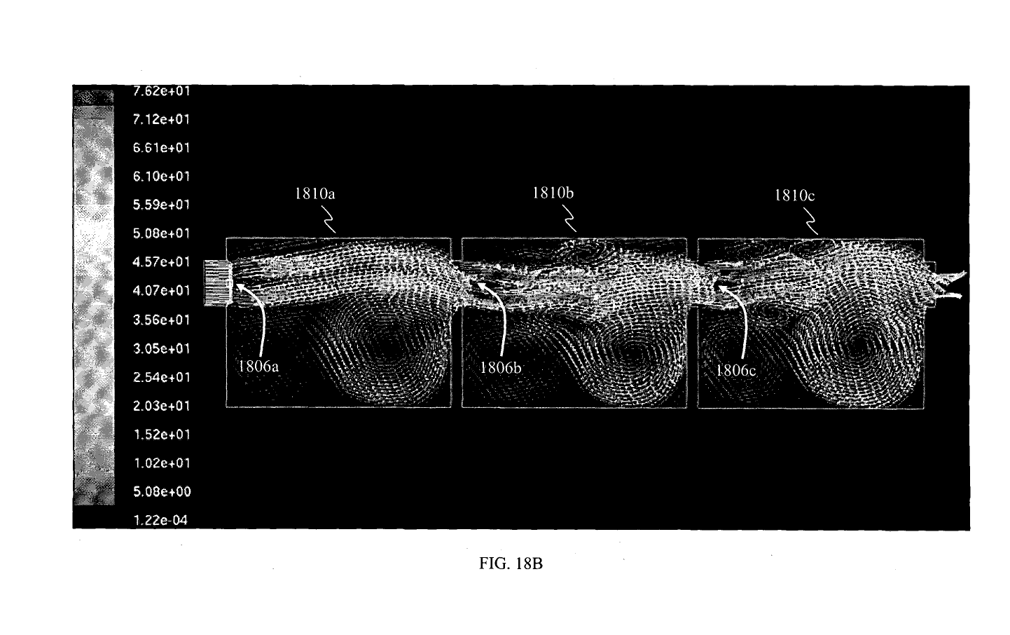

Similarly, the fluid characteristics of an array of cavities 1810a, 1810b, 1810c with bluff bodies 1806a, 1806b, 1806c, may also be simulated. The severity of the degree of turbulence, as shown in FIGS. 18A and 18B, is in the order of cavity III (1810c)>cavity II (1810b)>cavity I (1810a).

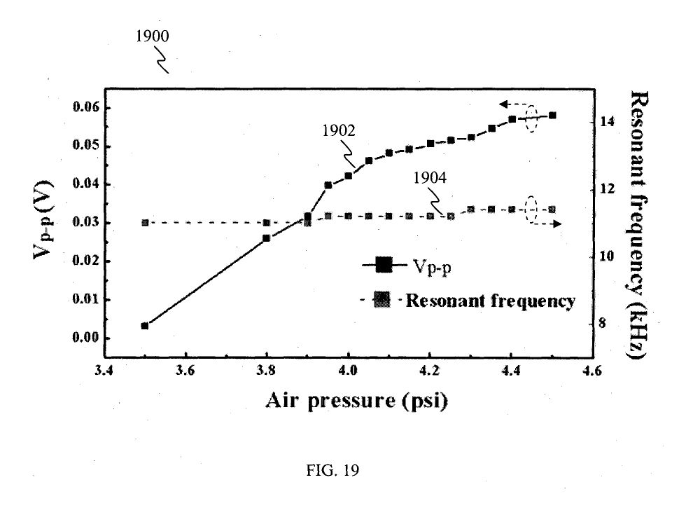

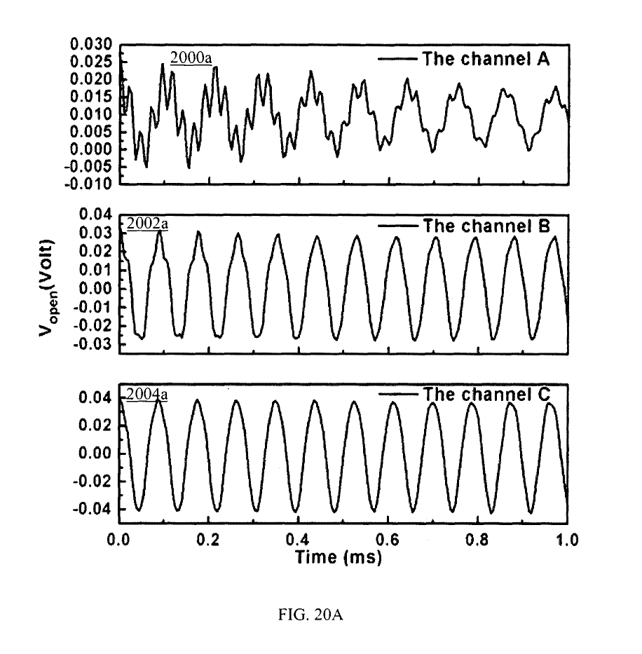

FIG. 19 shows a plot 1900 of the peak to peak output voltage 1902 and the resonant frequency 1904 versus the input air pressure. FIG. 19 illustrates the open circuit voltage spectrum (Vₒₚₑₙ) of different input air pressures (i.e. the flow rates). As may be observed, the minimum input operating pressure is about 3.5 psi and the resonant frequency is independent of the operating pressure. It is clear that a higher input pressure only leads to a higher Vₒₚₑₙ, but does not change the frequency spectra. This allows the energy harvesting device to operate at a universal frequency, greatly simplifying the circuitry.

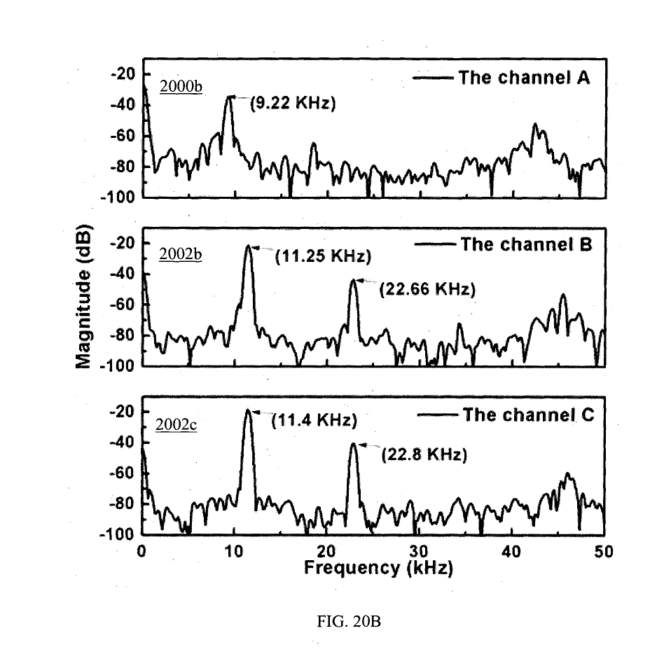

FIGS. 20A and 20B show plots of time spectra and frequency spectra, respectively, of Vₒₚₑₙ corresponding to an energy harvesting device with three cavities. The plots are obtained based on a 3D model of an energy harvesting device with a cavity array with bluff bodies, which may correspond to the energy harvesting device 1600c (FIG. 16C). The first Helmholtz cavity 1610a may be referred to as “Channel A”, the second Helmholtz cavity 1610b may be referred to as “Channel B” and the third Helmholtz cavity 1610c may be referred to as “Channel C”.

FIG. 20A shows plots 2000a, 2002a, 2004c of output voltages corresponding to each cavity 1610a, 1610b, 1610c respectively, while FIG. 20B shows plots 2000b, 2002b, 2004b of frequency spectra corresponding to each cavity 1610a, 1610b, 1610c respectively. The results shown in FIGS. 20A and 20B may be obtained at an input operating pressure of about 4.5 psi or under. It may be observed that only two major frequencies (e.g. about 11 kHz and about 22 kHz) may dominate the fluid vibration in the cavities. These frequencies may correspond to the first and second order modes of the Helmholtz resonance. In this way, the frequency behavior may be dominated by the Helmholtz resonating cavity.

Two observations may be made: 1) cavity geometry may determine the operating frequency; and 2) the bluff body may facilitate vibration and vibration regularity due to the vortex shedding effect. Fast Fourier transform (FFT) spectrum (results not shown) reveals that a majority of energy output for a device with a bluff body is located around the cavity resonant frequency, while a device without a bluff body has a wider frequency spectrum. These observations are in good agreement with the simulation results as shown in FIGS. 18A and 18B.

It should be appreciated that embodiments described in the context of FIGS. 3A to 6E may be are analogously valid for embodiments described in the context of FIGS. 13 to 16D, and vice versa.

In the context of various embodiments, a bluff body induced vortex shedding may have a relationship with inlet fluid velocity and a diameter of the bluff body. A narrow nozzle or microchannel as described herein may convert a low inlet fluid flow rate to a higher value, which may help to generate the phenomenon of vortex shedding.

In the context of various embodiments, the electromechanical coupling efficiency and the toughness of the materials of the energy harvesting elements may be different and may be suitable to be used in different occasions. Materials such as aluminum nitride (AlN), zinc oxide (ZnO), lithium niobate (LiNbO₃) and lead zirconate-titanate (PZT), among others, may be suitably employed. Well defined shapes of the energy harvesting elements may benefit from a large deformation of the energy harvesting elements. The the energy harvesting elements may be micro-belts, micro-cantilevers, micro-nets and micro-leafs/butterfly wings, among others.

Vibrational and/or shock energy may exist at low frequency with a broadband characteristics. Various embodiments may provide a method that may harvest energy by up-converting or up-converging the frequency of the energy. For example, vortex shedding may be induced with the help of a bluff body, a flow accelerating microchannel and a vortex shedding beam, and where a piezoelectric energy harvesting element or piezoelectric resonator may be employed to harvest energy. In this approach, the vortex shedding frequency may be wideband and may depend on the flow of the fluid. Further, various embodiments may also provide a method that may harvest energy by up-converting or up-converging the frequency of the energy, and also concentrating the broadband source into a sharp frequency with the help of a Helmholtz cavity or helmholtz resonating chamber. For example, vortex shedding and Helmholtz resonating effects may be employed, based on a Helmholtz cavity and a vortex shedding beam, and where a piezoelectric energy harvesting element or piezoelectric resonator may be employed to harvest energy. In this approach, the vortex shedding frequency may be at least substantially matched or coupled to the resonance frequency of the Helmholtz cavity. Further, the natural frequency of the piezoelectric energy harvesting element may be designed to be at least substantially matched to the resonance frequency of the Helmholtz cavity.

As described above, a bluff body enhanced MEMS Helmholtz resonator energy harvesting device may be provided to make full use of the low frequency portion of ambient energies. The vortex shedding effect induced by the bluff body placed in front of a piezoelectric micro-belt may initiate fluid resonating in the Helmholtz cavity. The operating frequency of the micro-belt may be pre-defined by the cavity size and independent of inlet fluid velocity and pressure. This structure design may provide a possibility to shrink the device size and improve the harvesting efficiency under lower flow rate or frequency ambient sources (e.g. flow rate of 1 m/s or even smaller).

As described above, various embodiments may provide a method for frequency up-conversion of an energy harvesting system or device, which may include forming one or more microchannels, one or more bluff bodies and one or more piezoelectric micro-belts or cantilever beams. The energy harvester device or system may include one or more fluid containers with microchannels, bluff bodies and piezoelectric micro-belts. The fluid container with microchannels may be used to generate and accelerate pressurized fluid flow from any pressure differential, acceleration or other source. The energy harvester with the bluff body may harvest these pressurized energy and convert them into electrical energy utilizing vortex shedding effect and piezoelectric coupling co-effect. The accelerated flow linear velocity and the bluff body may up-convert the low frequency of flow source, pressure differential or acceleration to high frequency vortex shedding fluid flow. The frequency up-conversion may improve the harvesting efficiency and shrink the size of the energy harvesters for implantation in bio applications, TPMS or other applications.

Further, various embodiments may provide an energy harvesting system or device arranged or adapted to harvest energy generated by fluid passing through a cavity of the device.

Various embodiments may also provide a bluff-body enhanced Helmholtz resonating cavity energy harvester as a miniaturization strategy of high efficiency to harvest low ambient energy. The device may enable a vortex shedding effect induced by a bluff body positioned in front of at least one energy harvesting element (e.g. piezoelectric micro-belt) which may facilitate initiation of Helmholtz resonance. At least one a narrow inlet nozzle or microchannel may accelerate inlet fluid flow speed, which may generate vortex shedding effect together with a bluff body in a miniature energy harvesting device. This may mean that a low frequency vibration energy may be transferred/accelerated into a pressurized high speed fluid by the narrow inlet nozzle, which may cooperate with the bluff body to generate vortex shedding so as to drive one or more high frequency piezoelectric energy harvesting elements. The operating frequency of the whole energy harvesting device or system may be pre-defined or determined by the size of the Helmholtz resonating cavity, which may be independent of the inlet fluid velocity or flow rate and pressure. Such a nozzle-bluff body-energy harvesting elements-Helmholtz cavity-nozzle structure (e.g. FIG. 14A) may help to shrink the size of the energy harvesting device and approach a high energy harvesting efficiency.

In various embodiments, the energy harvester system or device may include a compressible fluid container, which may transmit external low frequency motion to a pressurized fluid flow. This may be suitable, for example, for TPMS applications.

In various embodiments, a funnel-shaped structure may be connected to the inlet narrow nozzle or microchannel so as to facilitate coupling the fluid into the cavity of the energy harvesting device. This may be suitable, for example, for healthcare biomedical applications or oil/gas flow monitoring applications.

Various embodiments may provide one or more of the following: (1) CMOS (complementary metal-oxide-semiconductor) process compatibility, e.g. using a piezoelectric thin film such as AlN; (2) harvesting energy from a low frequency vibration source with hight efficiency; (3) the frequency up-conversion incorporated into the device of various embodiments may result in shrinking of the device size and increasing the energy harvesting efficiency; (4) the operating frequency may be independent of inlet fluid velocity and pressure, and determined only by the Helmholtz resonating cavity; or (5) the high energy harvesting efficiency may help to shrink the device size and extend the application realm.

While the invention has been particularly shown and described with reference to specific embodiments, it should be understood by those skilled in the art that various changes in form and detail may be made therein without departing from the spirit and scope of the invention as defined by the appended claims. The scope of the invention is thus indicated by the appended claims and all changes which come within the meaning and range of equivalency of the claims are therefore intended to be embraced.

1. An energy harvesting device comprising:
a microchannel arranged to receive a fluid;
a bluff body arranged to interact with the fluid flowing through the microchannel to generate a vortex fluid street; and
an energy harvesting element arranged to interact with the vortex fluid street to harvest energy from the fluid.

2. The energy harvesting device as claimed in claim 1, wherein the energy harvesting element is movable in response to the interaction with the vortex fluid street to convert kinetic energy into electrical energy.

3. The energy harvesting device as claimed in claim 1, wherein the energy harvesting element is configured to vibrate in response to the interaction with the vortex fluid street to convert kinetic energy into electrical energy.

4. The energy harvesting device as claimed in claim 1, wherein the energy harvesting element comprises a piezoelectric structure.

5. The energy harvesting device as claimed in claim 4, wherein the energy harvesting element further comprises a pair of electrodes arranged on opposite surfaces of the piezoelectric structure.

6. The energy harvesting device as claimed in claim 1, wherein the energy harvesting element is arranged in the path of the vortex fluid street to be generated.

7. The energy harvesting device as claimed in claim 1, wherein the bluff body is arranged between the microchannel and the energy harvesting element.

8. The energy harvesting device as claimed in claim 1, wherein the microchannel is arranged in up-flow direction of the fluid relative to the bluff body and the energy harvesting element is arranged in down-flow direction of the fluid relative to the bluff body

9. The energy harvesting device as claimed in claim 1, wherein the energy harvesting element is arranged in a cavity.

10. The energy harvesting device as claimed in claim 9, wherein the cavity comprises a Helmholtz cavity.

11. The energy harvesting device as claimed in claim 1, further comprising a plurality of microchannels arranged to receive the fluid.

12. The energy harvesting device as claimed in claim 1, further comprising a plurality of energy harvesting elements arranged to interact with the vortex fluid street.

13. The energy harvesting device as claimed in claim 12, wherein at least one energy harvesting element of the plurality of energy harvesting elements is arranged in a respective cavity, the cavities being arranged in fluid communication with each other.

14. The energy harvesting device as claimed in claim 1, further comprising a fluid container arranged in fluid communication with the microchannel, the fluid container configured to contain the fluid to be received by the microchannel.

15. The energy harvesting device as claimed in claim 14, wherein the fluid container is compressible.

16. The energy harvesting device as claimed in claim 1, further comprising:
an additional microchannel arranged to receive the fluid;
an additional bluff body arranged to interact with the fluid flowing through the additional microchannel to generate an additional vortex fluid street;
wherein the energy harvesting element is arranged to interact with the additional vortex fluid street.

17. The energy harvesting device as claimed in claim 1, wherein the energy harvesting element comprises at least one of: a micro-belt, a micro-blade, a micro-wire, a micro-cantilever beam, a double clamped beam, a micro-net, a micro-ring, a micro-leaf, or a butterfly wing

18. A method of harvesting energy, the method comprising:
receiving a fluid;
letting the fluid flow through a microchannel of an energy harvesting device;
arranging a bluff body of the energy harvesting device to interact with the fluid flowing through the microchannel to generate a vortex fluid street; and
arranging an energy harvesting element of the energy harvesting device to interact with the vortex fluid street to harvest energy from the fluid.

19. The method as claimed in claim 18,
wherein arranging a bluff body of the energy harvesting device to interact with the fluid flowing through the microchannel comprises arranging the bluff body at an inlet of a Helmholtz cavity of the energy harvesting device, and
wherein arranging an energy harvesting element of the energy harvesting device to interact with the vortex fluid street comprises arranging the energy harvesting element in the Helmholtz cavity.

20. The method as claimed in claim 19, further comprising letting the fluid flow out of the Helmholtz cavity through an additional microchannel of the energy harvesting device.
